(19) United States
(12) Patent Application Publication
(10) Pub. No.: US 2026/0104849 A1
(43) Pub. Date: Apr. 16, 2026

(54) AUDIO SPACIOUSNESS CONTROL

(71) Applicant: Sound United, LLC, Carlsbad, CA (US)

(72) Inventor: Brian Cox, Henderson, NV (US)

(21) Appl. No.: 19/354,750

(22) Filed: Oct. 9, 2025

Related U.S. Application Data
(60) Provisional application No. 63/705,969, filed on Oct. 10, 2024.

(51) Int. Cl. G06F 3/16; H04R 5/02; H04S 1/00; H04S 7/00

(52) U.S. Cl. CPC G06F 3/165; H04R 5/02; H04S 1/007; H04S 7/302; H04S 2400/11; H04S 2400/13

(57) ABSTRACT

Speaker systems can provide different levels of spaciousness. The speaker system can determine a type of audio to be played, and the speaker system can adjust the spaciousness based at least in part on the determined type of audio. The speaker system can have different default spaciousness values for different types of audio content. The speaker system can have a user interface that is configured to receive user input, and the speaker system can adjust the spaciousness based on the user input. The speaker system can permit the user to adjust the spaciousness within a defined range. The speaker system can apply different adjustable ranges for different types of audio content.

### CROSS-REFERENCE TO RELATED APPLICATIONS

This application claims the benefit under 35 U.S. C. § 119(e) of U.S. Provisional Ser. No. 63/705,969 , filed Oct. 10, 2024, and titled AUDIO SPACIOUSNESS CONTROL. The entirety contents of each of the above-identified application(s) are hereby incorporated by reference herein and made part of this specification for all that they disclose.

### BACKGROUND

### Field of the Disclosure

Some embodiments disclosed herein relate to speaker systems with variable spaciousness control.

### Description of the Related Art

Although some speaker systems can provide different levels of spaciousness, there is a continuing need for speaker systems with improved spaciousness control.

### SUMMARY OF CERTAIN EMBODIMENTS

Certain example aspects of the present disclosure are summarized below for illustrative purposes. The disclosure is not limited to the specific implementations recited herein. Aspects of the disclosure may include several novel features, no single one of which is solely responsible for its desirable attributes.

Various aspect of the disclosure relate to a speaker system, which can include a left driver; a right driver; an interface configured to receive spaciousness adjustment user input information (e.g., a user interface configured to receive user input); at least one processor; and computer-readable memory that contains first spaciousness settings for a first type of audio that includes a first default gain value, second spaciousness settings for a second type of audio that includes a second default gain value different from the first default gain value, and instructions that can be configured to be executed by the processor to cause the processor to: receive audio data that includes a left audio signal and a right audio signal; determine that the received audio data is the first type of audio; determine a difference signal based at least in part on a difference between the left audio signal and the right audio signal; apply the first default gain value from the first spaciousness settings for the first type of audio to the difference signal to produce a processed difference signal; produce a left audio output signal and a right audio output signal based at least in part on the processed difference signal; provide the left audio output signal to the left driver and provide the right audio output signal to the right driver to output sound having a default spaciousness for the first type of audio; receive user input information indicating a spaciousness adjustment; determine an adjustment gain value based at least in part on the received user input information; apply the adjustment gain value to produce an adjusted difference signal; produce an adjusted left audio output signal and a right adjusted audio output signal based at least in part on the adjusted difference signal; and provide the adjusted left audio output signal to the left driver and provide the adjusted right audio output signal to the right driver to output sound having an adjusted spaciousness.

The spaciousness adjustment user input information can be a command to incrementally widen or incrementally narrow the spaciousness of the output sound. The instructions can be configured to cause the processor to determine that the received audio data is a first type of audio based at least in part on user input information. The instructions can be configured to cause the processor to determine that the received audio data is a first type of audio based at least in part on a physical input source of the audio data. The instructions can be configured to cause the processor to determine that the received audio data is a first type of audio based at least in part on metadata of the audio data. The instructions can be configured to cause the processor to change from the first spaciousness settings for the first type of audio to the second spaciousness settings for the second type of audio based at least in part on user input information. The instructions can be configured to cause the processor to apply the first default gain value using a first signal processing element, and to apply the adjustment gain value by changing the first default gain value to an adjusted gain value applied by the same first signal processing element. The instructions can be configured to cause the processor to apply the first default gain value using a first signal processing element, and to apply the adjustment gain value using a second signal processing feature different from the first signal processing feature. The instructions can be configured to cause the processor to: determine a combination signal based at least in part on the left audio signal and the right audio signal, wherein the combination signal is indicative of similarity between the left audio signal and the right audio signal, apply a default combination signal gain value from the first spaciousness settings to the combination signal to produce a processed combination signal; produce the left audio output signal and the right audio output signal based at least in part on the processed combination signal; determine an adjustment combination gain value based at least in part on the received user input information; apply the adjustment combination gain value to produce an adjusted combination signal; and produce the adjusted left audio output signal and the right adjusted audio output signal based at least in part on the adjusted combination signal. The instructions can be configured to cause the processor to implement a first mixer configured to receive: a left audio signal; a left difference signal; and a combination signal. The first mixer can be configured to adjust gain to one or more of the received signals in response to the user input information indicating the spaciousness adjustment. The instructions can be configured to cause the processor to implement a second mixer configured to receive: a right audio signal; a right difference signal; and the combination signal. The second mixer can be configured to adjust gain to one or more of the received signals in response to the user input information indicating the spaciousness adjustment. The speaker system can include an additional left driver and an additional right driver, and the speaker system can be configured to enable user adjustment of the additional left driver and the additional right driver independent of the left driver and the right driver. The first spaciousness settings for the first type of audio can include a first default delay value, and the second spaciousness settings for the second type of audio can include a second default delay value, and the instructions can be configured to cause the processor to: apply the first default delay value from the first spaciousness settings for the first type of audio to the difference signal to produce the processed difference signal; determine an adjustment delay value based at least in part on the received user input information; and apply the adjustment delay value to produce the adjusted difference signal.

Various aspect of the disclosure relate to a speaker system, which can include multiple acoustic transducers; an interface configured to receive user input information; and one or more signal processing elements configured to: receive audio input signals; process the audio input signals according to spaciousness parameters; and provide audio output signals to the multiple acoustic transducers to produce sound that has spaciousness according to the spaciousness parameters.

The speaker system can be configured to determine a range of spaciousness parameters based at least in part on the received audio input signals or a selected audio mode. The speaker system can be configured to determine the spaciousness parameters based at least in part on user input and the determined range of spaciousness parameters. The speaker system can be configured to determine a type of audio based at least in part on the received audio input signals. The speaker system can be configured to determine the range of spaciousness parameters based at least in part on the type of audio. The speaker system can be configured to determine default spaciousness parameters based at least in part on the received audio input signals or a selected audio mode, and wherein the range of spaciousness parameters is between the default spaciousness parameters and maximum spaciousness parameters. The interface can be configured to receive a command to incrementally increase the spaciousness, and the speaker system can be configured to incrementally increase the spaciousness from the default spaciousness parameters toward the maximum spaciousness parameters in response to the command. The speaker system can be configured to determine a type of audio from the received audio input signals and to determine the range of spaciousness parameters based at least in part on determined type of audio. The speaker system can be configured to determine the range of spaciousness parameters based at least in part on metadata of the received audio signals. The one or more signal processing elements can be implemented using a digital signal processor. The one or more signal processing elements can include analog signal processing elements. The speaker system can be configured to adjust gain applied to a difference signal based on a difference between a first audio signal and a second audio signal to adjust the spaciousness of sound output by the speaker system. The speaker system can be configured to adjust delay applied to the difference signal to adjust the spaciousness of sound output by the speaker system. The speaker system can be configured to adjust a height of a soundstage produced by the speaker system.

Various aspect of the disclosure relate to a speaker system, which can include multiple acoustic transducers; an interface configured to receive user input information including a command to incrementally widen or narrow audio output by the multiple acoustic transducers; one or more signal processing elements configured to: receive audio input signals; and process the audio input signals and provide processed audio output signals to the multiple acoustic transducers. The speaker system can use the one or more signal processing elements to modify the processed audio output signals to incrementally widen or narrow the audio output by the multiple acoustic transducers.

The speaker system can be configured to determine a default width for the audio output by the multiple transducers. The speaker system can be configured to determine a type of audio for the audio input signal. The speaker system can be configured to determine the default width based at least in part on the type of audio. The default width for the audio can be determined from an audio mode that is set using a user interface. The interface can be configured to receive user command information to incrementally narrow the audio. The speaker system can be configured to incrementally narrow the audio from the default width towards a minimum width in response to the user command information. The speaker system can be configured to adjust gain applied to a difference signal based on a difference between a first audio signal and a second audio signal to adjust the spaciousness of audio output by the multiple acoustic transducers. The speaker system can be configured to adjust delay applied to a difference signal based on a difference between a first audio signal and a second audio signal to adjust the spaciousness of audio output by the multiple acoustic transducers. The speaker system can be configured to adjust a height of the audio output by the multiple acoustic transducers.

Various aspect of the disclosure relate to a non-transitory computer-readable memory that includes instructions that are executable by a processor to cause a speaker system to: receive audio data; determine an audio type for the audio data; determine a default spaciousness setting, a minimum spaciousness setting, and a maximum spaciousness setting based at least in part on the audio type; and provide a user interface configured to receive user input to enable user adjustment of the spaciousness between the minimum spaciousness setting and the maximum spaciousness setting.

The instructions can be configured to cause the speaker to determine the audio type for the audio data based one or more of: a physical input source for the audio data; a bitstream source for the audio data; a user input received by the user interface; and meta data for the audio data. The instructions can be configured to incrementally widen or incrementally narrow the spaciousness. The instructions can be configured to adjust gain applied to a difference signal that is based on a difference between a first audio signal and a second audio signal to adjust the spaciousness of audio output. The instructions can be configured to implement the other features disclosed above, or elsewhere herein.

### BRIEF DESCRIPTION OF THE DRAWINGS

Certain embodiments will be discussed with reference to the following figures, wherein like reference numerals can generally refer to similar features throughout. The figures are provided for illustrative purposes and the innovations are not limited to the specific implementations illustrated in the figures.

FIG. 1 shows an example speaker system and a user at a listening position.

FIG. 2 shows an example signal processing diagram for adjusting the spaciousness for audio produced by a speaker system.

FIG. 2 shows another example signal processing diagram for adjusting the spaciousness for audio produced by a speaker system.

FIG. 3 shows another example signal processing diagram for adjusting the spaciousness for audio produced by a speaker system.

FIG. 4 shows another example signal processing diagram for adjusting the spaciousness for audio produced by a speaker system.

FIG. 5 shows another example signal processing diagram for adjusting the spaciousness for audio produced by a speaker system.

FIG. 6 shows another example signal processing diagram for adjusting the spaciousness for audio produced by a speaker system.

FIG. 7 shows an example speaker system and a user in a listening environment.

FIG. 8 shows a graph of an example gain profile across a range of user adjustable input for the spaciousness setting.

FIG. 9 shows an example of spaciousness settings for two-channel audio content.

FIG. 10 shows an example of spaciousness settings for ATMOS or DTS: X audio content.

FIG. 11 shows a graph that compares the gain profiles for an example of two channel music audio and two channel movie audio.

FIG. 12 shows an example embodiment of a speaker system with multiple drivers.

FIG. 13 shows another example embodiment of a speaker system with multiple drivers.

### DETAILED DESCRIPTION OF CERTAIN EMBODIMENTS

The various features and advantages of the systems, devices, and methods of the technology described herein will become more fully apparent from the following description of the examples illustrated in the figures. These examples are intended to illustrate the principles of this disclosure, and this disclosure should not be limited to merely the illustrated examples. The features of the illustrated examples can be modified, combined, removed, and/or substituted as will be apparent to those of ordinary skill in the art upon consideration of the principles disclosed herein.

Different types of audio content can benefit from different spaciousness settings. For example, a relatively narrow soundstage may be appropriate for a podcast, whereas a relatively wide soundstage may be preferrable for movie audio or for music. Also, different users may have different personal preferences for spaciousness, even for the same audio content. Furthermore, the environment or purpose of the audio can affect the appropriate spaciousness for the situation. For example, a relatively wide soundstage may be preferrable when a user is using the speaker system for listening to a music track at an on-axis location or otherwise optimized listening position. However, if that same music track were being played on the speaker system to provide background music during a party with many listeners spread out throughout the listening space, then a relatively narrow soundstage may be more appropriate.

Speaker systems disclosed herein can provide different levels of spaciousness. In some cases, the speaker system can determine a type of audio to be played, and the speaker system can adjust the spaciousness based at least in part on the determined type of audio. In some implementations, the speaker system can have different default spaciousness values for different types of audio content. In some cases, the speaker system can have a user interface that is configured to receive user input, and the speaker system can adjust the spaciousness based on the user input. The speaker system can permit the user to adjust the spaciousness within a defined range. In some cases, the speaker system can apply different adjustable ranges for different types of audio content. The speaker systems can include various other features as disclosed herein.

The features disclosed herein can be used with various types of speaker systems. In some implementations, the features disclosed herein can be used with one or more of the speakers disclosed in U.S. Patent Application Publication No. 2024/0080594, published on Mar. 7, 2024, and titled SPEAKERS, which is hereby incorporated by reference for all that it discloses.

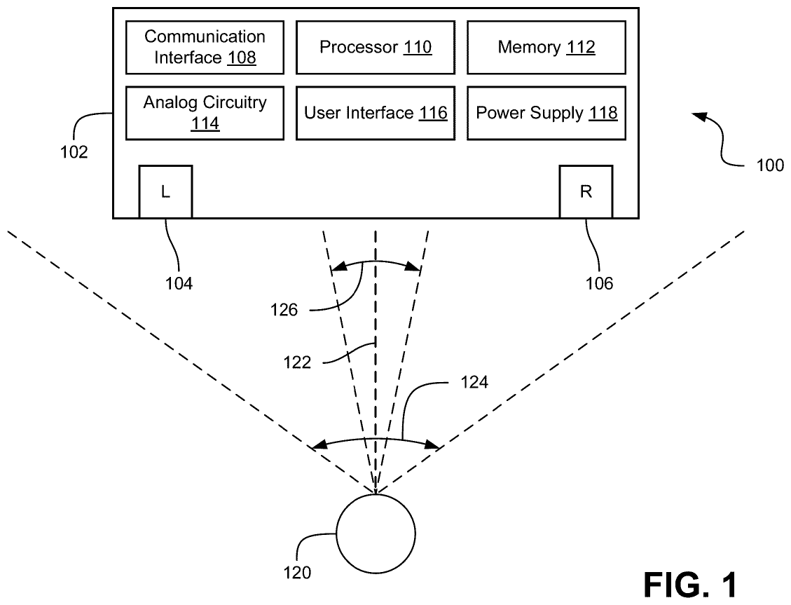

FIG. 1 is an example of a speaker system 100. The speaker system 100 can include a housing 102. The speaker system 100 can include a first driver 104, which can be a left-side driver, and a second driver 106, which can be a right-side driver. The drivers 104 and 106 can be supported by the housing 102. The speaker system 100 can be sound-bar or other single-enclosure speaker system, although other configurations can also be used. The drivers 104 and 106 can be mid-range drivers and/or tweeters, or any other suitable type of acoustic transducers. In some embodiments, the speaker system 100 can include left and right mid-range driver and also left and right mid-range tweeters. Although the speaker system 100 can include additional drivers, for simplicity of explanation, some embodiments are discussed in connection with an example having a left driver 104 and a right driver 106.

The speaker system 100 can include a communication interface 108, which can receive audio data to be used by the speaker system 100 to produce sound, such as using the drivers 104 and 106. The communication interface 108 can receive multiple channels of audio data, such as a left channel audio data and a right channel audio data. In some implementations, data for additional channels can be received, but the example of FIG. 1 is discussed in connection with audio data that includes left and right channels. The communication interface 108 can receive additional information, such as meta data, audio source information, audio type, etc. In some cases, the communication interface 108 can receive a bitstream of data, which can include audio data, and additional data in some cases.

The communication interface 108 can include one or more physical ports or connectors configured to receive corresponding connectors or ports, such as for wired communication. For example the communication interface 108 can include one or more of HDMI ports or connectors, speaker pin connectors or receivers, RCA ports or connectors, banana plug ports or connectors, USB ports or connectors, optical ports or connectors, or any other suitable types of connections for transferring audio data and/or associated information. In some cases, the communication interface 108 can be a wired communication interface. In some cases, the communication interface 108 can be a wireless communication interface, which can use one or more wireless communication protocols, such as WiFi, Bluetooth, or any other suitable wireless communication system suitable for transferring audio data and/or associated information.

The speaker system 100 can include at least one processor 110, which can be a hardware processor, and which can be configured to operate the speaker system 100 as described herein. The processor 110 can be a digital signal processor, which can processes audio signals, as described herein. The processor 110 can control or operate other features of the speaker system 100, such as receiving and interpreting user input information from the user interface 116. In some cases, a general purpose processor can be used to perform various tasks, such as by executing instructions stored in memory 112. The speaker system 100 can include multiple processors 110, which can perform distributed processing and/or can perform different tasks to operate the speaker system 100. In some cases, one or more application-specific integrated circuits (ASICs) can be used to perform various features disclosed herein. For example, in some cases, discrete signal processing circuits can be used for performing different signal processing tasks.

The speaker system 100 can include computer-readable memory 112, which can be non-transitory computer-readable memory. The memory 112 can include instructions, which can be executed by the one or more processors 110, such as to operate the speaker system 100 as discussed herein. The memory 112 can include one or more programs, applications, or executable modules, which can perform the various functions and features described herein. The memory 112 can store various values and parameters, as discussed herein, such as default spaciousness values, user settings, spaciousness adjustment ranges, equalization filter parameters, etc. The memory 112 can store one or more databases or lookup tables for implementing the features discussed herein. In some cases, the memory 112 can be divided between multiple physical memory units and/or types. For example, some information can be stored in read-only memory, whereas other information can be stored in writable memory, and various other memory configurations could be used. In some embodiments, information or instructions can be stored externally, and can be accessed via the communication interface 108.

In some configurations, the speaker system 100 can include analog circuitry 114, which can perform analog audio signal processing, such as to implement the features discussed herein. Although some examples are discussed herein in connection with digital signal processing, such as to adjust audio spaciousness, analog signal processing can also be used to implement many of the features discussed herein.

In some cases, the speaker system can include an analog-to-digital converter, which can convert analog audio signals and to digital audio signals. If the communication interface 108 receives analog audio signals, the analog-to-digital converter can receive those analog signals and can output corresponding digital signals, which can be used by the processor 110, for example. In some cases, the speaker system 100 could include a digital-to-analog converters which can convert digital audio signals to analog audio signals, such as if the speaker system uses analog circuitry 114 for performing the signal processing (e.g., for adjusting spaciousness).

The speaker system 100 can include a user interface 116, which can be configured to receive user input. For example, the user interface 116 can include one or more buttons, dials, switches, or other user input elements. In some cases, the user interface 116 can include a touchscreen display. The user interface 116 can include capacitive touch elements or other input elements configured to detect touch events. In some cases, the user interface 116 can include a user interface ring as disclosed in the '594 Publication. The user interface 116 can include a microphone configured to receive audio input from the user, such as voice commands. The speaker system 100 can be configured to adjust the audio spaciousness in response to a voice command from the user. In some cases, a user interface element or device (e.g., a keyboard or mouse) can be coupled to the speaker system via a U/I port or connector. In some cases, the user interface can include a remote control device, which can be separate from the housing 102 of the speaker system 100, and which can communicate with the speaker system 100 by an infrared wireless communication protocol or over WiFi or using Bluetooth or any other suitable communication protocol. In some cases, the user interface 116 can communicate with an application running on a separate computing device, such as a smartphone, tablet computer, smart watch, wearable computing device, personal computer, etc. For example, the speaker system 100 can include an interface configured to receive user input information, such as for adjusting spaciousness settings, as discussed herein. In some cases, the interface can include the user interface 116 itself, which can receive the user input directly from the user. In some cases, the interface can be a communication interface configured to communicate with an external user interface to receive the user input information from the external user interface (e.g., from a smartphone).

The user interface 116 can output information to the user. For example, the user interface 116 can include a display to output visual information (e.g., as text or images) to a user. One or more lights can be used, which can use flashing patterns or colors to communicate information to a user. In some cases the user interface 116 can use one or more of the drivers 104, 106 to output sound information to the user. For example, when a spaciousness setting is adjusted, the user interface 116 can cause the drivers 104 and 106 to play a beep or other sound to indicate the change.

The speaker system 100 can include a power supply 118. The power supply 118 can provide power to operate the drivers 104 and 106, the processor 110, and the other components of the speaker system 100. The speaker system 100 can be an active speaker 100 with an incorporated amplifier for driving the drivers 104 and 106. The power supply 118 can received electricity from a wired connection to a power outlet, in some cases. The power supply 118 can include one or more power converters, which can change AC power to DC power and can provide appropriate voltage levels to the various electrical components of the speaker system 100. In some cases, the power supply 118 can be a battery, which can be contained in the speaker housing 102. The speaker system 100 can be a portable speaker system. The battery can be charged by a wired power connection or by a wireless charging interface (e.g. inductive charging).

The speaker system 100 can output sound with various different spaciousness parameters. FIG. 1 shows a user 120 at an on-axis listening position. The listening position in FIG. 1 is substantially equally distanced from the left driver 104 and the right driver 106. However, different spaciousness settings may also be appreciated from other (e.g., off-axis) listening positions. Spaciousness control can enable a user to adjust between a relatively wide sound stage and a relatively narrow soundstage. The spaciousness, wideness, or narrowness, of the sound can depend on how different the sound produced by the left driver 104 is from the sound produced by the right driver 106. For example, if the same signal (e.g., a mono signal) is provided to both the left driver 104 and the right driver 106, then all of the sounds produced by the speaker system 100 can sound like they are coming from a center position (e.g., along the axis 122) for an on-axis listener equidistant from the left driver 104 and the right driver 106. This so-defined listening location may be regarded as the listening “sweet spot.” This approach can provide the most narrow soundstage, or least amount of spaciousness. If different signals are provided to the left driver 104 and the right driver 106, those differences can provide a sense of width, which can give the user 120 the impression that the sounds are coming from a wider area, rather than from the center position. If the differences between the signals provided to the left driver 104 and the right driver 106 are greater, that can produce a relatively wider soundstage 124, which can give the impression of the sounds coming from positions that are spaced further apart. If the differences between the signals provided to the left driver 104 and the right driver 106 are smaller, that can produce a relatively narrow soundstage 126, which can give the impression of the sounds coming from positions that are positioned closer together (e.g., but still separated by a distance).

Different amounts of spaciousness or widening can be appropriate for different types of audio content. Some audio content can benefit significantly from a wide soundstage, such as a binaural recording, whereas a narrow soundstage may be preferable for other audio content, such as a podcast. The speaker system 100 can adjust the spaciousness based at least in part on the audio content, such as based on the input type, the audio source, the type of bitstream, audio metadata, etc.

Different users can have different personal preferences for spaciousness. The speaker system 100 can enable a user to adjust the spaciousness, such as by input provided to the user interface 116. The user 120 could provide input to the user interface 116 to adjust the spaciousness to use a single-enclosure speaker system (e.g., a speaker system disclosed in the '594 Publication) to mimic the soundstage of two separate stereo speakers that are spaced 12 feet apart, or at a 60 degree spread, for example. Many other configurations and soundstages can be set by the user.

The appropriate spaciousness can depend on the user's position or on the use of the audio content. For example, in some cases a wide soundstage can be presented best at an on-axis (e.g., sweet spot) listening location, such as the location of the user 120 in FIG. 1, or at another specific location for which the soundstage is optimized. Accordingly, the user 120 may want a wide soundstage during focused listening to an audio track while sitting at the on-axis listening position shown in FIG. 1. However, if the same user is walking around the room, the relatively wide soundstage the sound distribution from the left driver 104 and the right driver 106 can change the listening experience as the user changes location, so a more narrow soundstage may be more appropriate. Also, if multiple listeners are present, such as during a house party, a wide sound stage can result in different users at different locations receiving different listening experiences. Generally, the effect of a wide soundstage can breakdown as the listening position moves off-axis or away from the optimized location. A more narrow soundstage can provide a more uniform listening experience across the listening space. The speaker system 100 can receive user input via the user interface 116 to adjust the spaciousness, such as based on the use of the audio. In some embodiments, the speaker system 100 can detect a use case and adjust the spaciousness based at least in part on the detected use case, as discussed herein.

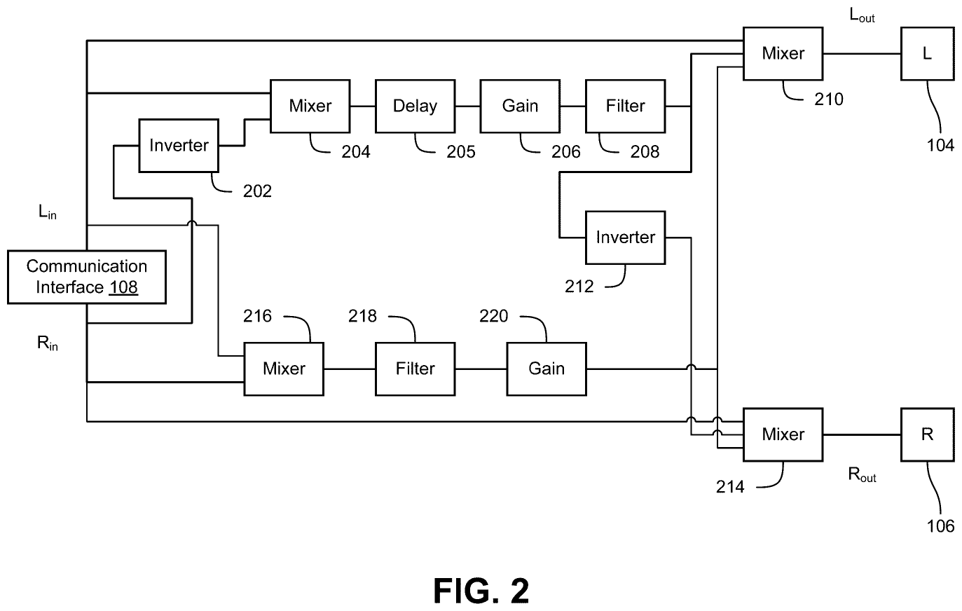

FIG. 2 shows an example signal processing diagram for adjusting the spaciousness for audio produced by the speaker system 100. The signal processing can be implemented by the processor 110, which can be a digital signal processor, or by analog circuitry, or any other suitable arrangement of signal processing features. The signal processor can access two channels of audio, which can be an Rᵢₙ signal and an Lᵢₙ signal. The two channels can be received by the communication interface 108, in some cases, such as from two wired connections, or from a single wired connection, or from a bit stream that is received wirelessly, etc. The speaker system 100 can perform signal processing on the Rᵢₙ signal and the Lᵢₙ signal to produce an Rₒᵤₜ signal and an Lₒᵤₜ signal, which can be provided to the respective right driver 106 and left driver 104.

The Rᵢₙ signal can be inverted by an inverter 202, and the inverted signal can be provided to a mixer 204. The Lᵢₙ signal can be provided to the mixer 204, which can combine (e.g., sum) the inverted Rᵢₙ signal and the Lᵢₙ signal. The mixer 204 can output a signal that represents a difference between the Lᵢₙ signal and the Rᵢₙ signal. The difference signal can be provided to a delay controller 205, which can introduce a delay to the difference audio signal. The delay can cause the sound produced by the difference signal to play at a delayed time (e.g., relative to the sound components produced by the Lᵢₙ and Rᵢₙ signals). The amount of delay applied to the difference signal can be used to control the spaciousness, as discussed herein. For example, less delay can yield less spaciousness and more delay can yield more spaciousness. The delayed difference signal can be provided to a gain controller 206, which can amplify or attenuate the difference signal. One or more filters 208 can be applied to the difference signal, such as to adjust the equalization. The processed difference signal can be provided to a mixer 210 that can be used to produce the Lₒᵤₜ signal. The processed difference signal can be provided to an inverter 212, which can invert the processed difference signal, and the inverted and processed difference signal can be provided to the mixer 214 that can be used to produce the Rₒᵤₜ signal. The signal can be inverted (again) by inverter 212 to preserve the original phase. The mixer 210 for the left driver 104 and the mixer 214 for the right driver 106 can receive opposite signals that are both based on the difference between the Lᵢₙ signal and the Rᵢₙ signal, which can be emphasized to widen the soundstage.

The Rᵢₙ signal and the Lᵢₙ signal can be provided to a mixer 216, which can combine (e.g., sum) the Rᵢₙ signal and the Lᵢₙ signal. Because neither of the Rᵢₙ signal and the Lᵢₙ signal are inverted the mixer 216 can be used to produce a signal representing or emphasizing what is the same in the Rᵢₙ signal and the Lᵢₙ signal. The combined signal output by the mixer 216 can effectively be a mono signal that is a combination of the Rᵢₙ signal and the Lᵢₙ signal. One or more filters 218 can be applied to the combined signal, such as to adjust the equalization. The combined signal can be provided to the gain controller 220, which can amplify or attenuate the combined signal. The processed combined signal can be provided to the mixer 210 that can be used to produce the Lₒᵤₜ signal and to the mixer 214 that can be used to produce the Rₒᵤₜ signal. The combined signal can be a mono recovery channel. In some situations, the mono recovery channel can be used to balance a high degree of widening while maintaining a level of mono content such as for dialog or vocals. In some cases, the combined signals can be emphasized to narrow the soundstage.

The example mixer 210 can receive a first input that can be the Lᵢₙ signal. The mixer 210 can receive a second input that can be a difference signal that is based on the difference between the Lᵢₙ signal and the Rᵢₙ signal. The mixer 210 can receive a third input that can be the combined signal that is based on the similarity of the Lᵢₙ signal and the Rᵢₙ signal. The mixer 210 can adjust the relative power between the three input signals. The mixer 210 can turn the three inputs up or down independently to adjust the spaciousness, as discussed herein.

The example mixer 214 can receive a first input that can be the Rᵢₙ signal. The mixer 214 can receive a second input that can be a difference signal that is based on the difference between the Lᵢₙ signal and the Rᵢₙ signal (e.g., an inverted difference signal). The mixer 214 can receive a third input that can be the combined signal that is based on the similarity of the Lᵢₙ signal and the Rᵢₙ signal. The mixer 214 can adjust the relative power between the three input signals. The mixer 214 can turn the three inputs up or down independently to adjust the spaciousness, as discussed herein.

By way of example, by adjusting the mixers 210 and 214 to turn off the first and second inputs and to turn on the third inputs, the speaker system 100 can provide the same combined signal to both the left driver 104 and the right driver 106, which can provide a mono output, which can be effectively the most narrow soundstage setting. As the power of the third inputs is reduced and/or as the power of the first and/or second inputs of the mixers 210 and 214 is increased, the soundstage can be made wider. By way of example, by adjusting the mixers 210 and 214 to turn off the second and third inputs and by turning on the first inputs, the speaker system can provide stereo audio output with the standard Lᵢₙ and Rᵢₙ signals. By turning on the second inputs and by increasing the power of the second inputs on the mixers 210 and 214, the speaker system can increasingly emphasize the difference between the left and right signals and can increase the width of the soundstage. In some implementations, the amount of delay applied by the delay controller 205 can be increased to increase the width of the soundstage. Various different setting between these examples, and different sets of configurations, can be used to provide various different soundstage widths and varying degrees of spaciousness for the output audio.

The spaciousness can be controlled by adjusting the relative gain applied to the different inputs provided to the mixer 210 and/or the mixer 214. Alternatively, or additionally, the spaciousness can be controlled by adjusting the gain applied by the gain controller 206 to the difference signal and/or by adjusting the gain applied by the gain controller 220 to the combination signal. In some cases, signal combiners can be used in place of the mixer 210 and/or the mixer 214 to combine (e.g., sum) the signals. Alternatively, or additionally, the spaciousness can be controlled by adjusting the delay applied by the delay controller 205 to the difference signal.

Many different signal processing systems can be used to produce adjustable signals for controlling the spaciousness of audio output from the speaker system 100. For example, many variations can be applied to the example implementation of FIG. 2, some of which will be discussed herein. For example, the mixer 204 and/or the mixer 216 can be signal combiners that combine the two input signals to equal degrees (e.g., 50/50). In some embodiments, the filter 208 and/or the filter 218 can be omitted, or can be applied differently, such as at a different location. For example, the Lᵢₙ signal and the Rᵢₙ signal can be filtered before being provided to the signal processing features discussed in FIG. 2, and/or the Lₒᵤₜ signal and the Rₒᵤₜ signal can be filtered after the mixers 210 and 214. The order of the gain controllers 206 and 220 and the filters 208 and 218 can be changed. Also, the position of the delay controller 205 can be changed. For example, the delay controller 205 can be between the gain controller 206 and the filter 208, or it can be after the filter 208, in some implementations. In some embodiments, the delay controller 205 can be omitted, and the spaciousness can be adjusted without using the delay features discussed herein. In some cases, the gain controller 206 and/or the gain controller 220 can be omitted. The power of the difference signal and the combination signal can be adjusted by the mixers 210 and 214, without any prior amplification or attenuation. In some cases, separate adjustable amplifiers and/or attenuators can be used for the three inputs or a subset thereof. The mixer 210 and/or the mixer 214 can be replaced by any other suitable signal combiners.

In some cases, the third inputs to the mixers 210 and 214 can be omitted, such as for a speaker system that can produce stereo audio with a default-width soundstage or wider, without offering a narrowing adjustment. In some cases, the second inputs can be omitted, such as for a speaker system that can produce stereo audio with a default-width soundstage or narrower, without offering a widening adjustment.

In some cases, the inverters 202 and 212 can be moved from the R-signal side to the L-signal side. For example, the inverter 202 can be moved to between Lᵢₙ and the mixer 204 and/or the inverter 212 can be moved to between the filter 208 and the mixer 210. The inversion of the L-signal or the R-signal can depend on how the signals are combined at block 204.

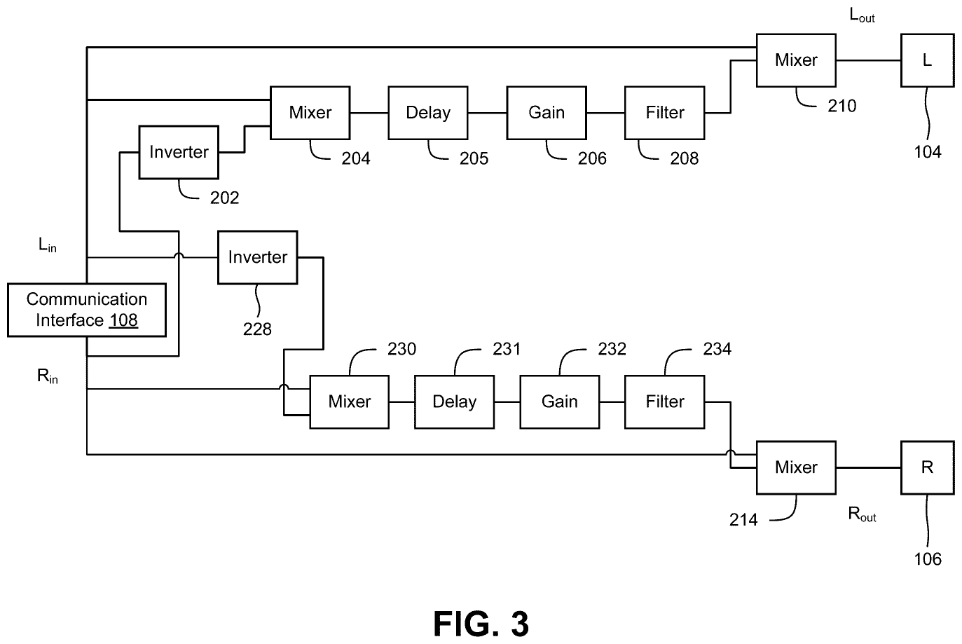

In some cases, the left and right difference signals can be determined separately, rather than one being the inverted signal of the other. FIG. 3 shows another example embodiment, which can be similar to the example of FIG. 2, except as discussed herein. The Lᵢₙ signal can be inverted by inverter 228. The mixer 230, or other signal combiner, can receive the inverted Lᵢₙ signal and the Rᵢₙ signal and can output a second difference signal based on the difference between the Rᵢₙ signal and the Lᵢₙ signal. The delay controller 231 can apply a delay to the difference signal. The gain controller 232 can amplify or attenuate the difference signal, and one or more filters 234 can be applied to the difference signal (e.g., for equalization). The processed second difference signal can be provided to the mixer 214, which can be used to produce the Rₒᵤₜ signal. In some cases, the mixers 210 and 214 can also receive the third inputs (e.g., a combined signal that is based on the similarity of the Lᵢₙ signal and the Rᵢₙ signal), which are omitted from view in FIG. 3.

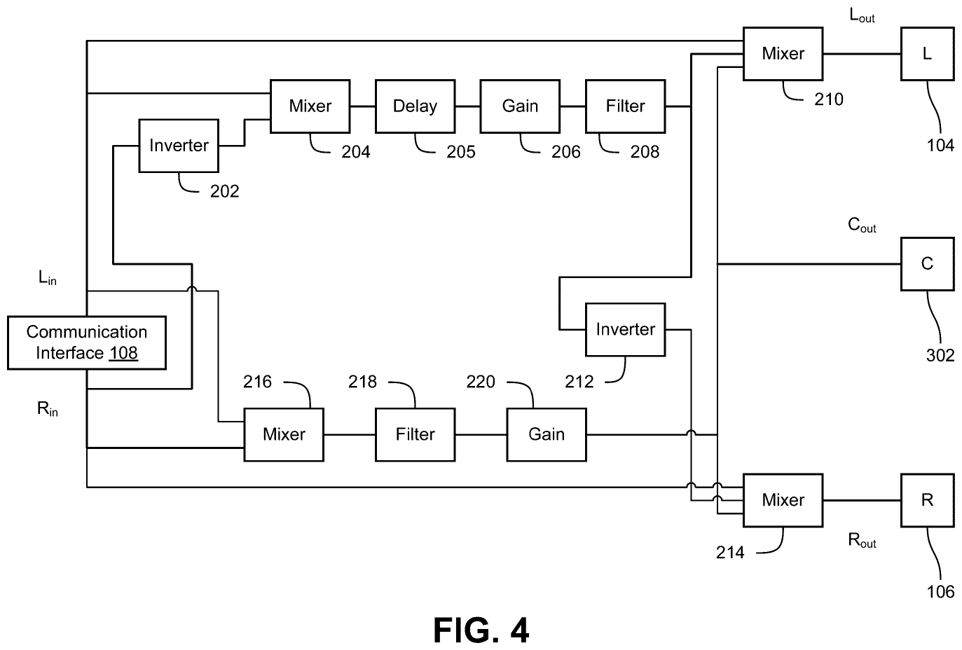

With reference to FIG. 4, in some cases, the speaker system 100 can include a center driver 302, which can be driven by a Cₒᵤₜ signal. The Cₒᵤₜ signal can be based at least in part on a combination of the Lᵢₙ signal and the Rᵢₙ signal. For example, the combination signal output from the combiner or mixer 216, the filter 218, and/or the gain controller 220 can be delivered to the center driver 302, as shown in FIG. 4. The same signal provided to the third inputs of the mixer 210 and the mixer 214 can be provided to the center driver 302.

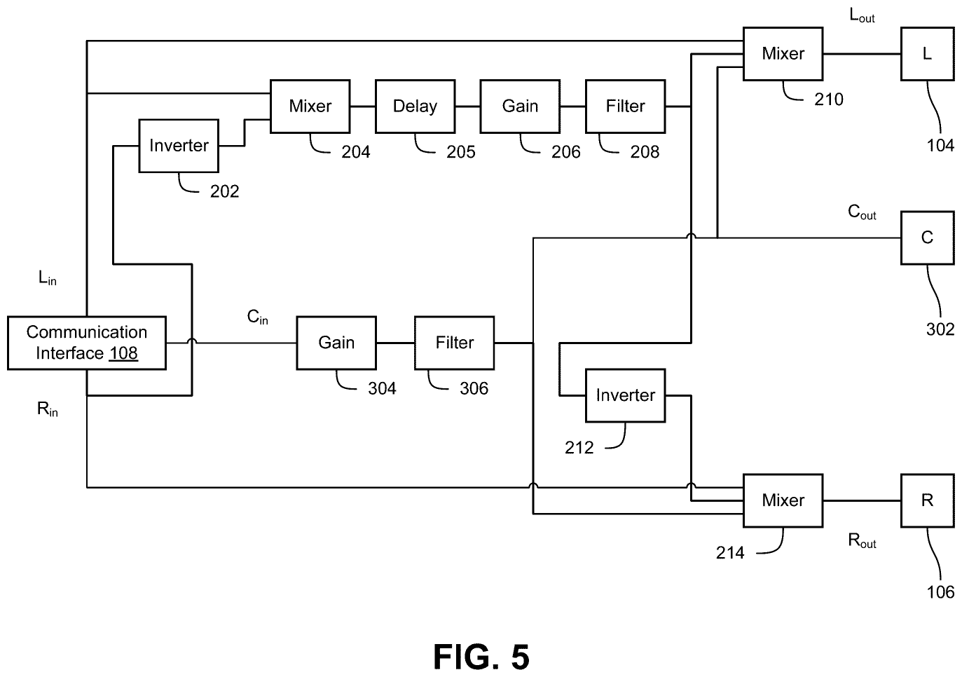

With reference to FIG. 5, in some cases, the speaker system 100 can include a center driver 302, which can be driven by a Cₒᵤₜ signal. The signal processor can access audio content with three channels, for right, left and center channels, such as an Rᵢₙ signal, an Lᵢₙ signal, and a Cᵢₙ signal. The three channels can be received by the communication interface 108, in some cases, such as from three wired connections, or from a single wired connection, or from a bit stream that is received wirelessly, etc. The Cᵢₙ signal can used to drive the center driver 302. The Cᵢₙ signal can be delivered to a gain controller 304, which can amplify or attenuate the Cᵢₙ signal. One or more filters 306 can adjust the Cᵢₙ signal, such as for equalization. The processed center signal can be provided as a Cₒᵤₜ signal to the center driver 302. The processed center signal can be delivered to the mixer 210 and/or to the mixer 214, for example as the third inputs. The center signal input(s) can be emphasized to narrow the soundstage, as discussed herein. In some cases, the gain controller 304 and/or the filter(s) 306 can be omitted. In some cases, the Cᵢₙ signal can be presented to the center driver 302 as a Cₒᵤₜ signal without processing. The Cᵢₙ signal can be delivered to the mixer 210 and/or to the mixer 214, for example as the third inputs.

Many variations are possible. In some cases, the center signal that is used as the third inputs in FIG. 5 can be combined with the combination (e.g., mono) signal that is used as the third inputs in FIG. 2. For example, a signal combiner (e.g., a mixer) can be combine the center signal third input of FIG. 5 with the combination signal third input of FIG. 2, and the output of that signal combiner can be used as the third inputs for the mixer 210 and/or for the mixer 214. In some implementations, the mixer 210 and/or the mixer 214 can receive both the center signal input (e.g., the third input of FIG. 5) and the combination signal (e.g., the third input of FIG. 2), and the mixer 210 and/or the mixer 214 can use either of both to produce the Lₒᵤₜ and Rₒᵤₜ signals. For example, the mixers 210 and 214 can include four inputs, in some cases. In some implementations, a mixer for the center driver 302 can receive the Lᵢₙ and Rᵢₙ signals, or a combination thereof, as well as the Cᵢₙ signals. For example, for a narrow soundstage or a mono configuration, the center driver 302 can be driven with a combination of the Lᵢₙ signals, the Rᵢₙ signals, and the Cᵢₙ signals. In some cases, the center driver 302, the left driver 104, and the right driver 106 (e.g., all the drivers, in some implementations) can be driven with a combination of the Lᵢₙ signals, the Rᵢₙ signals, and the Cᵢₙ signals (e.g., a combination of all the input signals, in some implementations).

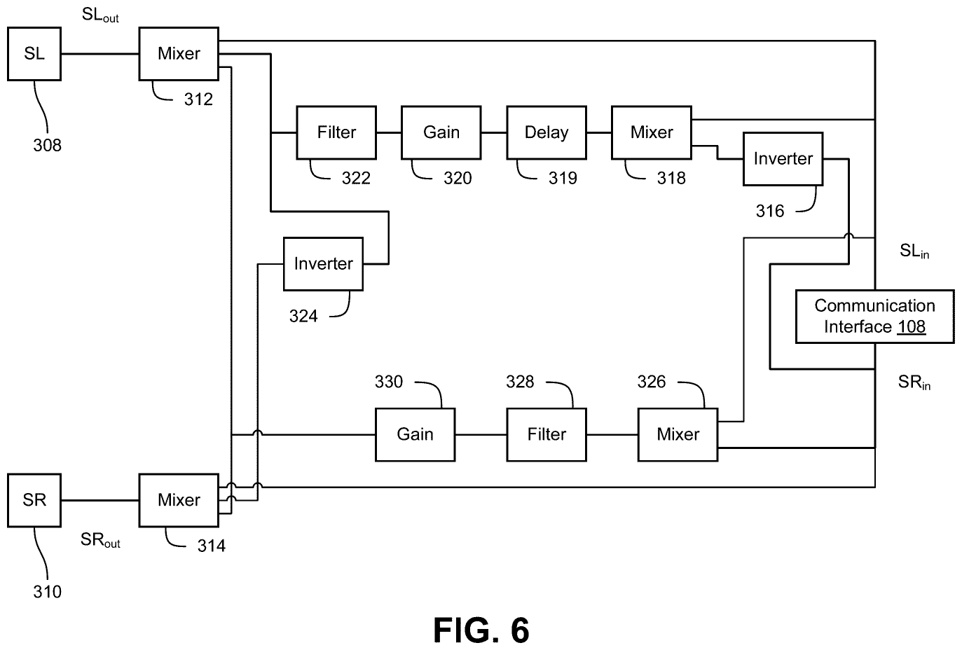

In some embodiments, the speaker system 100 can include additional drivers, such as left and/or right rear surround drivers, left and/or right side surround drivers, and/or one or more height drivers (e.g., left and/or right front height drivers). The left driver 104 and the right driver 106 discussed herein can be left and right front drivers, in some configurations. Other pairs of left and right drivers (e.g., rear surrounds, side surrounds, or height/ATMOS drivers, etc.) can be used. FIG. 6 shows an example that includes a left surround driver 308 (e.g., a left rear surround driver), and a right surround driver 310 (e.g., a right rear surround driver). The signal processor can access two channels of audio, which can be an SRᵢₙ signal and an SLᵢₙ signal. The two channels can be received by the communication interface 108, in some cases, such as from two wired connections, or from a single physical connection, or from a bit stream that is received wirelessly, etc. In some implementations, the speaker system can access 6 (e.g., 5.1) channels of audio content. In other implementations, 7 channels, or 9 channels, or any other suitable number of audio channels can be used. For example, the features of FIG. 6 can be combined with the features of any of FIGS. 2 to 5.

The speaker system 100 can perform signal processing on the SRᵢₙ signal and the SLᵢₙ signal to produce an SRₒᵤₜ signal and an SLₒᵤₜ signal, which can be provided to the respective right surround driver 310 and left surround driver 308, in a similar manner to the other embodiments disclosed herein. By way of example, the signal processor can include a mixer 312 that can output the SLₒᵤₜ signal and a mixer 314 that can output the SRₒᵤₜ signal. The SRᵢₙ signal can be provided to an inverter 316, which can output an inverted signal. A mixer 318 or other signal combiner can combine (e.g., sum) the inverted SRᵢₙ signal with the SLᵢₙ signal. The mixer 318 can output a signal that is representative of a difference between the SLᵢₙ signal and the SRᵢₙ signal. The output of the mixer 318 can be provided to a gain controller 320, which can attenuate or amplify the signal. One or more filters 322 can be applied to the signal, such as for equalization. The difference signal can be provided to the mixer 312, for example as the second mixer input in FIG. 6. The difference signal can be inverted by an inverter 324, and that inverted difference signal can be provided to the mixer 314, for example as the second input of the mixer 314 in FIG. 6. The mixer 312 can receive the SLᵢₙ signal, for example as the first mixer input, and the mixer 314 can receive the SRᵢₙ signal, for example as the first mixer input.

In some implementations, the mixer 312 and/or the mixer 314 can include a third input, which can be a mono signal, a center channel signal, or a combination of the SRᵢₙ signal and the SLᵢₙ signal (e.g., that is representative of the commonality of the SRᵢₙ signal and the SLᵢₙ signal). For example, the SLᵢₙ signal and the SRᵢₙ signal can be provided to a mixer 326 or other signal combiner, which can output a combined (e.g., summed) signal. One or more filters 328 can be applied to the combined signal, such as for equalization. A gain controller can attenuate or amplify the combined signal. The combined signal can be provided to the mixer 312 and/or to the mixer 314, for example as the third input(s). The mixer 312 and the mixer 314 can be used to narrow or widen the soundstage, similar to the other embodiments discussed herein. Many variations are possible, similar to the other signal processing embodiments discussed herein.

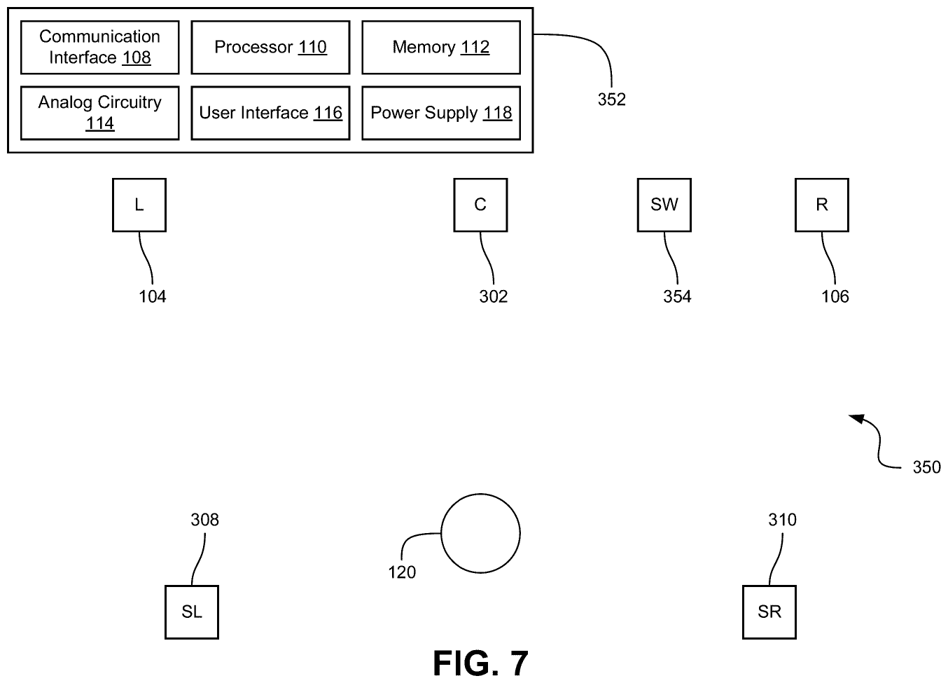

FIG. 7 shows an example speaker system 350, which can use an audio controller 352 (e.g., an audio amplifier, an AV receiver, or other suitable audio device) and one or more external speakers that are not integrated into the audio controller 352. The external speakers can be passive speakers, which can be driven by one or more amplifiers of the audio controller 352. The external speakers can be coupled to the audio controller 352 by wired connections, which can deliver power and/or information to the speakers. In some cases, the audio controller 352 can communicate with the external speakers wirelessly. The external speakers can have their own power sources and/or amplifiers to drive the transducer(s) of the external speakers in response to data received (e.g., wirelessly) from the audio controller 352. The external speakers can have a single driver or multiple drivers (e.g., one or more tweeters and/or one or more mid-range drivers).

The example of FIG. 7 shows a 5.1 surround system, but other audio systems and configurations can be used, such as with additional channels or with fewer channels. The speaker system 350 can include a center speaker, which can have at least one center C driver 302, a front left speaker, which can have at least one left L driver, a front right speaker, which can have at least one right R driver, a rear or side surround left speaker, which can have at least one surround left SL driver 308, a rear or side surround right speaker, which can have at least one surround right SR driver 310. The system can optionally include a subwoofer, which can include a subwoofer SW driver 354. Additional speakers could be included, and some speakers could be omitted.

The audio controller 352 can include a communication interface 108, a processor 110, memory 112, analog circuitry 114, a user interface 116, and/or a power supply 118, which can operate similar to the speaker system 100, except that the audio controller 352 can be used to drive one or more external speakers or drivers. Many variations are possible. For example, the audio controller 352 can include some drivers integrated therewith (e.g., the L, C, and R) drivers, and the audio controller 352 can be also used with one or more external speakers (e.g., having the SL and SR drivers).

The user interface 116 can enable a user to adjust the spaciousness, such as by incremental changes rather than merely switching between different preset sound modes. By way of example, the user interface 116 can include a user input element that permits the user to set the spaciousness setting at integer increments between a setting of −50, which can correspond to a minimum spaciousness or most narrow soundstage configuration, and +50, which can correspond to a maximum spaciousness or most wide soundstage configuration. In some cases the 0 value can correspond to a default spaciousness setting. In this example, the speaker system can enable the user to incrementally adjust the spaciousness between 101 available settings, with the default setting of 0, and with 50 available steps of increased spaciousness or widening, and with 50 available steps of decreased speciousness or narrowing. Any other suitable number of incremental steps can be used, such as 5, 10, 20, 30, 50, 70, 100, 150, 200, 250, 500, 750, 1000, or more, or any values or ranges between any of these values. In some cases, the speaker system can provide for incremental adjustment of spaciousness that can be infinitely adjustable with smooth adjustment between maximum and minimum spaciousness settings, such as using a dial or knob or other suitable user input element (e.g., using analog signal processing components). In some cases, the spaciousness can be incrementally adjusted by defined steps (e.g., using digital signal processing), which in some cases can be sufficiently granular to provide the user with the impression of smooth adjustment.

In response to user input to the user interface 116, the speaker system can adjust one or more parameters to change the spaciousness of the sound output by the speaker system. With reference to the examples of FIGS. 1 and 2, the user interface 116 can receive user input indicating a change to the spaciousness setting, such as a change from the default setting (e.g., 0) to a wider setting (e.g., +20). In response to the user input, the processor 110 can change the gain applied to one or more signals, such as to increase the gain applied by the gain controller 206 (e.g., from −9 dB to −5.4 dB) and to decrease the gain applied by the gain controller 220 (e.g., from −7 dB to −55.4 dB). Increasing the gain applied to the difference signal and/or decreasing gain applied to the combination signal can widen the soundstage for sound produced by the drivers 104 and 106. Alternatively, the gain can be adjusted by the mixer 210 and the mixer 214. For example, the mixer 210 can increase the gain of the second input difference signal (e.g., from −9 dB to −5.4 dB) and can decrease the gain of the third input combination signal (e.g., from −7 dB to −55.4 dB), and the mixer 214 can increase the gain of the second input inverted difference signal (e.g., from −9 dB to −5.4 dB) and can decrease the gain of the third input combination signal (e.g., from −7 dB to −55.4 dB), such as to widen the soundstage. In some implementations, some gain can be adjusted by the gain controller 206 and/or the gain controller 220, and some additional gain adjustment can be performed by the mixer 210 and/or the mixer 214. For example, in some cases, the mixer 210 and the mixer 214 can be used to change the relative gain settings to adjust spaciousness based on changes between sound modes (e.g., between a movie mode, a music mode, a 2-channel input mode, an ATMOS mode, or a DTS:X mode, etc.), whereas the gain controller 206 and/or the gain controller 220 can be used to adjust the gain settings based on incremental adjustments to spaciousness in response to user input. Many alternatives are possible. In some cases, gain values can be determined from both the sound mode and the user input that enables incremental spaciousness adjustment (e.g., using one or more look-up tables or a formula), rather than separately applying the gain values corresponding to the sound mode and the user adjustment.

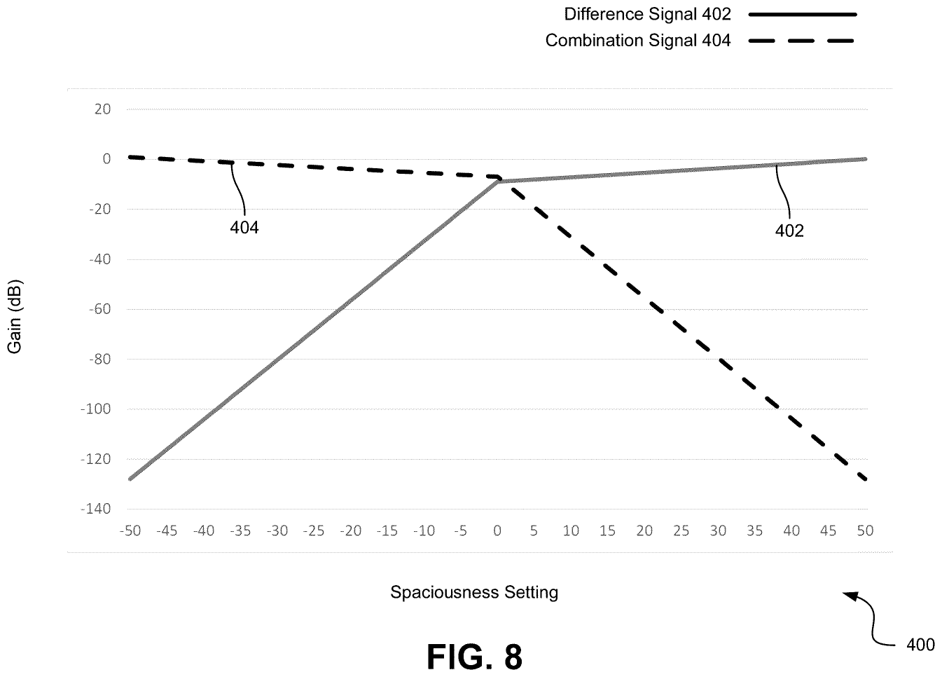

FIG. 8 shows a graph of an example gain profile across the range of user adjustable input for the spaciousness setting. Line 402 shows the gain applied to the difference signal across the user-selectable spaciousness values. Line 404 shows the gain applied to the combination signal across the user-selectable spaciousness values. In this example, at a spaciousness setting of 0 (e.g., which can be a default setting), the gain for the difference signal 402 can be −9 dB and the gain for the combination signal can be −7 dB. As the spaciousness setting is increased, the gain for the difference signal 402 can increase while the gain for the combination signal 404 can decrease. As the spaciousness setting is decreased, the gain for the combination signal 404 can increase while the gain for the difference signal can decrease. Although the lines in the example of FIG. 8 are linear from the default setting (e.g., 0) toward the minimum setting (e.g., −50) and the maximum setting (e.g., +50), in other cases the gain values can be increased and/or decreased non-linearly. Many variations and alternatives are possible. In some cases, the combination signal gain 404 an be omitted, for example, and the spaciousness adjustment can be performed by adjusting only the difference signal. In some cases, additional parameters can be changed when the spaciousness is adjusted. For example, with reference to FIG. 2, the L and R signals provided to the first inputs of the mixer 210 and the mixer 214 can be adjusted to emphasize to deemphasize the difference between the channels, to adjust the spaciousness. In some cases, the filter parameters (e.g., at the filter(s) 208 and/or the filter(s) 218) can be changed as the spaciousness settings are adjusted). The filter parameters can be based on one more of the type of audio content, the type of pre-processing (or third party processing) performed on the audio signals, the audio mode of the speaker system, audio input type or source, bitstream type, and the user input.

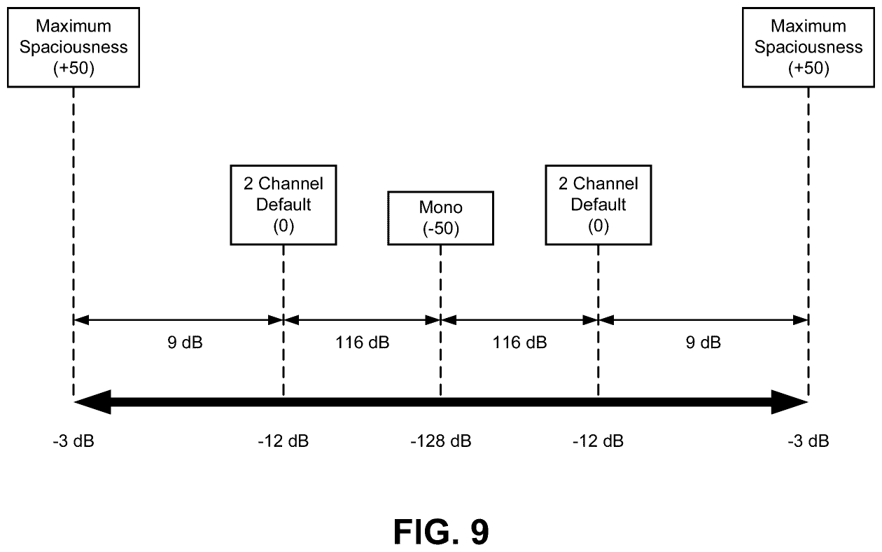

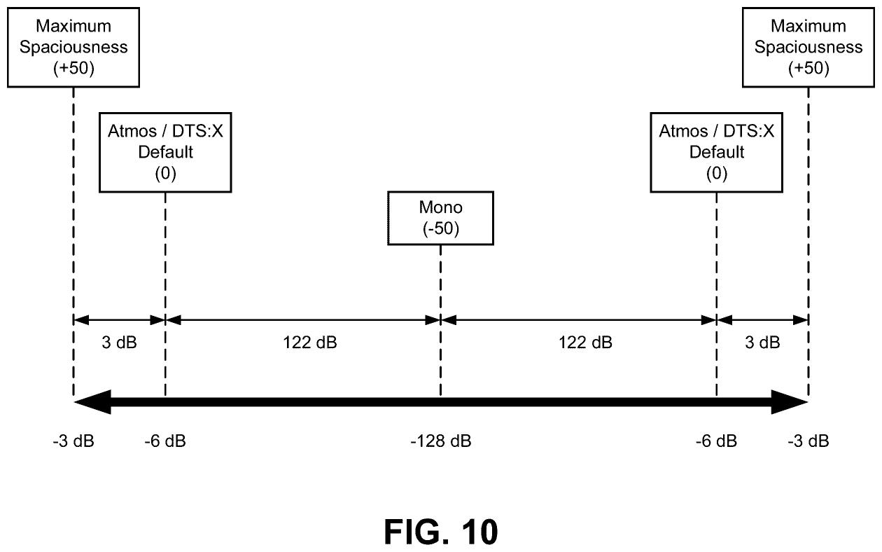

The spaciousness can depend on the type of audio content or mode being presented. For example, the speaker system can use different default spaciousness parameters for different types of audio. FIG. 9 shows an example for two-channel audio content, and FIG. 10 shows an example for ATMOS or DTS: X audio content. For a first audio content (e.g., the two-channel audio content of FIG. 9), a default spaciousness setting (e.g., 0) can cause the speaker system to apply a first level of spaciousness (e.g., −12 dB of gain applied to the difference signal). For a second audio content (e.g., the ATMOS or DTS: X audio content of FIG. 10), the same default spaciousness setting (e.g., 0) can cause the speaker system to apply a second level of spaciousness (e.g., −6 dB of gain applied to the difference signal). Although FIGS. 9 and 10 are discussed in connection with the gain applied to the difference signal, other gain values (e.g., to a combination signal) and other parameters can also have different values based on the types of audio, similar to the discussion herein.

In the examples of FIG. 9 and FIG. 10, the minimum spaciousness setting (e.g., −50) can cause the speaker system to output the same minimum level of spaciousness for both the first and second types of audio, which can be mono sound (e.g., provided by applying −128 dB to the difference signal, as shown in FIGS. 9 and 10). Also, the maximum spaciousness setting (e.g., +50) can cause the speaker system to output the same maximum level of spaciousness for both the first and second types of audio (e.g., which can be provided by applying −3 dB of gain to the difference signal, as shown in FIGS. 9 and 10). Although FIGS. 9 and 10 only shows the difference signal gain, other parameters (e.g., that affect spaciousness) can also change values based on the spaciousness setting. For example, with a minimum spaciousness setting (e.g., −50), the gain for the combined (e.g., L+R) signal have a relative high or maximum level of gain. In some cases, the minimum spaciousness setting (e.g., −50) can cause the left driver 104 signal (e.g., Lₒᵤₜ) and right driver signal (e.g., Rₒᵤₜ) can be substantially the same signal (e.g., based on a combined L+R signal), so that both sides play the same audio. This approach can effectively make mono sound out of stereo signals, 5.1 formats, or other formats, etc. This approach can provide the most even coverage of all content around the room.

Spaciousness adjustments input by the user can produce different amounts of spaciousness changes based on the type of audio content or mode. For example, in FIGS. 9 and 10, since the different types of audio content or modes have different default spaciousness parameters, different ranges of spaciousness increase and decrease are available for the different types of audio content or modes. In FIG. 9, increasing the spaciousness from the default value (e.g., 0) to the maximum value (e.g., +50) causes an increase of 9 dB of gain to the difference signal. In FIG. 10, increasing the spaciousness from the default value (e.g., 0) to the maximum value (e.g., +50) causes an increase of 3 dB of gain to the difference signal. Each incremental increase in the spaciousness setting can produce a larger change in the spaciousness in the example of FIG. 9 than in the example of FIG. 10. In FIG. 9, decreasing the spaciousness from the default value (e.g., 0) to the minimum value (e.g., −50) causes a decrease of 116 dB of gain to the difference signal. In FIG. 10, decreasing the spaciousness from the default value (e.g., 0) to the minimum value (e.g., −50) causes a decrease of 122 dB of gain to the difference signal. Each incremental decrease in the spaciousness setting can produce a smaller change in the spaciousness in the example of FIG. 9 than in the example of FIG. 10.

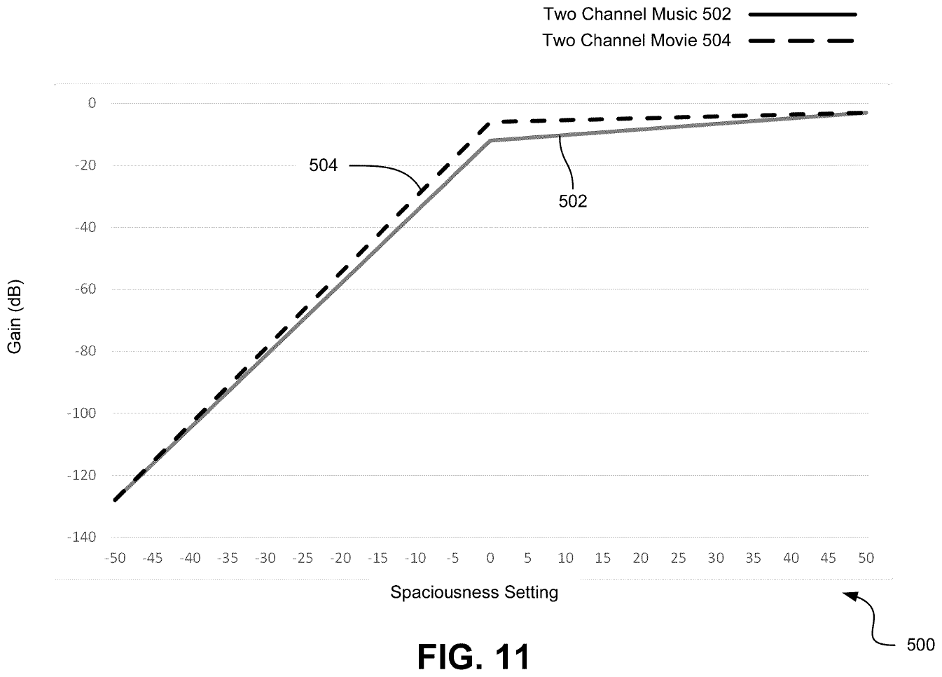

FIG. 11 shows a graph that compares the gain profiles for different types of audio. Line 502 represents the gain (e.g., to the difference signal) for two-channel music audio 502, and line 504 represents the gain (e.g., to the difference signal) for two-channel movie audio 504. At the default spaciousness setting (e.g., 0), the gain for two-channel music audio can be −12 dB and the gain for two-channel movie audio can be −6 dB. As the spaciousness setting is increased toward the maximum value (e.g., +50), the gain for two-channel music audio can increase (e.g., from −12 dB to −3 dB) at a first rate, and the gain for two-channel movie audio can increase (e.g., from −6 dB to −3 dB) at a second rate different than the first rate. As the spaciousness setting is decreased toward the minimum value (e.g., −50), the gain for two-channel music audio can decrease (e.g., from −12 dB to −128 dB) at a third rate, and the gain for two-channel movie audio can decrease (e.g., from −6 dB to −128 dB) at a fourth rate that is different from the third rate. The third and fourth rates can be different from the first and second rates. Although the lines in the example of FIG. 11 are linear from the default setting (e.g., 0) toward the minimum setting (e.g., −50) and the maximum setting (e.g., +50), in other cases the gain values can be increased and/or decreased non-linearly. Although FIG. 11 only shows the difference signal gain, other parameters (e.g., that affect spaciousness) changes in the spaciousness setting can also change the values of other parameters, such as the combination signal gain, the dedicated L or R signal gain, the mixer settings for mixer 210, mixer 214, the setting for filters 208 and/or filter 218, etc.

The speaker system can have a maximum limit to how wide the soundstage can be, and additional processing to widen beyond that maximum limit may degrade the sound or otherwise become counterproductive. Accordingly, the speaker system can be configured to apply that maximum spaciousness limit to all or multiple types of audio content or sound modes. In some implementations, the speaker system can apply different maximum spaciousness parameters and/or different minimum spaciousness parameters for different types of audio content and/or to different sound modes of the speaker system. For example, the example of FIG. 11 can be modified so that lines 502 and 504 do not converge to the same values at the minimum spaciousness setting (e.g., −50) or at the maximum spaciousness setting (e.g., +50).

Multiple factors can determine the adjustable range and/or default values for the spaciousness parameters. In some implementations, the adjustable range and/or default values for the spaciousness parameters can be based at least in part on additional audio processing, which can be third party processing such as Dolby ATMOS, DTS Virtual: X, etc. By way of example, in some instances, the speaker system can apply Dolby ATMOS processing, and the speaker system can apply different default, minimum, and/or maximum spaciousness parameters when the Dolby ATMOS processing is applied. Other parameters can be applied when other types of audio processing are applied, such as DTS Virtual: X. Accordingly, the speaker system can determine the spaciousness parameters (e.g., available ranges for adjustment and/or default values) based on whether additional audio processing is applied and based on what type of additional audio processing is applied. The spaciousness parameters can be determined based on both the type of audio content and the type of processing applied to the audio content. The processor 110 can apply the additional processing, and can produce the Lᵢₙ and Rᵢₙ signals discussed herein, as well as other signals to drive additional drivers, as also discussed herein. For example, with reference to FIGS. 1 and 2, the communication interface 108 can receive audio signals, and the processor 110 can perform Dolby ATMOS processing (or any other suitable processing) to produce the Lᵢₙ and Rᵢₙ signals shown in and discussed in connection with FIG. 2. As discussed, the spaciousness parameters can be determined based at least in part on that Dolby ATMOS (or other) pre-processing (e.g., based on the pre-processing type).

In some embodiments, the speaker system 100 can receive audio data that has already been pre-preprocessed (e.g., using Dolby ATMOS or other suitable processing type), and the audio data received by the speaker system 100 can include metadata with information about the pre-processing (e.g., the pre-processing type and/or parameters). The speaker system 100 can determine the spaciousness parameters (e.g., the adjustable ranges and/or default values) based as least in part on the pre-processing information (e.g., from the metadata).

The memory 112 of the speaker system can include one or more lookup tables with various parameters to control the spaciousness of the speaker system based at least in part on adjustment input provided to the user interface 116 and/or based at least in part on the type of audio content or audio mode of the system. In some cases, the processor 110 can apply one or more formulas to determine parameters for setting the spaciousness of the speaker system based at least in part on adjustment input provided to the user interface 116 and/or based at least in part on the type of audio content or audio mode of the system. The memory 112 can store instructions to cause the processor 110 to implement the formula(s) or lookup table operations to control the spaciousness of the speaker system, as discussed herein.

Various parameters can be used to control the spaciousness, as discussed herein. One, or more, or each of those parameters can have an adjustable range, a minimum value, a maximum value, and/or a default value, which can be determined based on one more of the type of audio content, the type of pre-processing (or third party processing) performed on the audio signals, the audio mode of the speaker system, audio input type or source, bitstream type, and the user input. The user interface can enable the user to adjust the spaciousness, which can adjust the parameters within the determined adjustable range. By way of example, the speaker system can be configured to provide 101 incremental spaciousness settings, with a setting at 0 for a default spaciousness setting, with settings from +1 to +50 for incrementally wider spaciousness, and with settings from −1 to −50 for incrementally wider spaciousness. Each of the 101 incremental spaciousness settings can have corresponding values for the various parameters that can control the spaciousness. The values that correspond to the 101 incremental spaciousness settings can be different for different types of audio content, different types of pre-processing (or third party processing) performed on the audio signals, different audio modes of the speaker system, different audio input types or sources, different bitstream types, or different user inputs (e.g., which can specify an audio type or mode or use case). These sets of values can be stored in the memory 112, for example as lookup tables. The various sets of values (e.g., the sets of minimum, maximum, default, and intermediate values) can be set (e.g., by a sound designer or by the user) for the individual speaker system, such as based on the types and number of drivers, the locations of the drivers, the desired acoustical properties of the system, etc. In some embodiments, the system can store fewer parameter values than the number of adjustable spaciousness steps, and the system can interpolate between stored values to determine the values to apply for the various parameters. For example, the system can have 101 incremental spaciousness steps, and the system can include 5, 10, 15, 25, 50, 75, 100, or 101 stored values for any given parameter, or any ranges or numbers therebetween.

The difference signal gain (e.g., applied at the gain controller 206 and/or at the mixers 210 and 214) can affect the spaciousness. Generally, increased difference signal gain can produce wider spaciousness, and decreased difference signal gain can produce narrower spaciousness. The speaker system 100 can have several (e.g., 101) values for the difference signal gain, which can be applied based on user input to adjust the spaciousness. Different sets of available values for the difference signal gain can be used based on one more of the type of audio content, the type of pre-processing (or third party processing) performed on the audio signals, the audio mode of the speaker system, audio input type or source, bitstream type, and the user input.

The combination or center signal gain (e.g., applied at the gain controller 220 and/or at the mixers 210 and 214) can affect the spaciousness. Generally, increased combination or center signal gain can produce narrower spaciousness, and decreased combination or center signal gain can produce wider spaciousness. The speaker system 100 can have several (e.g., 101) values for the combination or center signal gain, which can be applied based on user input to adjust the spaciousness. Different sets of available values for the combination or center signal gain can be used based on one more of the type of audio content, the type of pre-processing (or third party processing) performed on the audio signals, the audio mode of the speaker system, audio input type or source, bitstream type, and the user input.

A delay setting (e.g., applied at the delay controller 205) can affect the spaciousness. Generally, increased delay can produce wider spaciousness, and decreased delay can produce narrower spaciousness. The minimum user-specified spaciousness setting can apply no delay, for example. The speaker system 100 can have several (e.g., 101) values for the delay setting, which can be applied based on user input to adjust the spaciousness. Different sets of available values for the delay setting can be used based on one more of the type of audio content, the type of pre-processing (or third party processing) performed on the audio signals, the audio mode of the speaker system, audio input type or source, bitstream type, and the user input. Various different types of delay can be used, such as delay of the difference signal, as discussed herein. Delay between the L and R signals can also widen the soundstage, in some implementations.

The filter or equalization parameters (e.g., applied at the block 208 and/or at block 218) can affect the spaciousness and/or can be adjusted to be tailored to various levels of spaciousness. By way of example, when applying a relatively large spaciousness (e.g., for a wide soundstage), it can be beneficial to attenuate higher frequency sounds. Also, different speaker systems can benefit from different types of filtering, which can shift based on the applied spaciousness. One filter element can be applied, or a series of multiple filter elements can be applied. For each of the filter element(s) various parameters can be adjusted, such as the filter type, the filter frequency, the filter gain, and/or the filter Q can be adjusted. The filter element(s) can apply various filter types, such as lowpass filters, highpass filters, bandpass filters, low shelf filters, high shelf filters, parametric Peak EQ filters, or any other suitable types of filters. The speaker system 100 can have several (e.g., 101) values for various filter parameters (e.g., gain or Q values), which can be applied based on user input that adjusts the spaciousness. Different sets of available values for the filter parameters can be used based on one more of the type of audio content, the type of pre-processing (or third party processing) performed on the audio signals, the audio mode of the speaker system, audio input type or source, bitstream type, and the user input.

When producing low spaciousness or mono sound, various speakers can be driven by various signals that are combined together. In a simple example, some or all of the L, R, C, LS, RS, LE, and RE signals can be combined and used to drive all of the drivers. However, in some cases the combined signals might not produce desirable sounds. For example, L-surround and R-surround signals that have gone through Dolby processing might not add together to make a natural sounding (or flat measuring) mono signal. The similar effects can apply to combining LE, RE signals and to combining L, R signals. Therefore, the speaker system can perform filtering or equalization processing (e.g., in terms of dB magnitude) to produce good mono or low-spaciousness sound. In turn, the equalization parameters can vary along with the available adjustable spaciousness settings. The equalization parameters can vary based on the particular configuration of the drivers in the speaker system.

By way of example, a speaker system can receive multiple channels of audio signals (e.g., a 5.1.2 signal or any combination of center, left, right, left-surround, right-surround, bass or subwoofer (optionally), left-elevation, and right-elevation signals, although additional channels could also be used). To enable adjustment between a wide soundstage with high spaciousness and a narrow soundstage with low spaciousness or mono sound, several equalization (EQ) parameters can be adjusted with the spaciousness control, such as both difference signals EQ (e.g., for widening) and combination signal or Mono EQ (e.g., for summing to mono). By way of example, the system can use seven parametric EQ bands for a channel pair (e.g., the L/R channel pair, the LS/RS channel pair, and/or the LE/RE channel pair) the for the respective difference signals EQ, and another seven parametric EQ bands for a channel pair combination or mono signal EQ. Each parametric EQ can be defined by three parameters: frequency, dB gain, and Q. In this example, some or all of these 42 parameters for the channel pair (e.g., the L/R channel pair) can vary across the range of the adjustable spaciousness control. Each channel pair can have different EQ parameters, in some embodiments. Some EQ parameters can vary across the full range of available spaciousness. In some cases, an EQ parameter can change as the spaciousness increases but remain the same as the spaciousness decreases, or vice versa. Many alternatives and variations are possible, such as a different number of parametric EQ bands, additional or fewer EQ parameters, and various values of the parameters for different spaciousness amounts, such as depending on the particular speaker system.

By way of example, the spaciousness control can involve varying delay, mixer values, and/or gain, such as for the difference signal(s) and/or the combination signal(s) as discussed herein. In some cases, the system can use unique values for gain, mixer values, and/or delay for 2-channel music for the L/R channel pair to implement spaciousness control, as discussed herein. In some implementations, increasing the gain on the difference signal can have the biggest effect on widening the sound. The system can use a set of EQ values for the L/R channel pair, which values can vary based on the spaciousness settings, as discussed herein.

For examples with additional channels, such as for 5.1.2 signals or Atmos Movie content, there can be a L/R channel pair, but there can be additional channel pairs (e.g., LS/RS and LE/RE). For the L/R channel pair, the L/R difference EQ settings can be shared between 2-channel music and 5.1.2/Atmos uses cases (e.g., using the same table of values). However, the L/R combination signal or mono EQ can be not the same between 2-channel music and 5.1.2/Atmos. This can be in part due to the Dolby processing already applied in the Atmos use case. As above, the spaciousness control can involve varying mixer values, delay, and/or gain, which values for 5.1.2/Atmos/movie content can be different from the 2-channel/music values. The LS/RS and/or LE/RE channel pairs can each use additional spaciousness control values (e.g., for gain, delay, and/or mixer values) and can each use additional EQ parameter values (e.g., seven-band difference signal EQ parameters and seven-band combination or mono signal EQ parameters).

The speaker system can have several values for some or all of the EQ parameters, which can be applied based on user input as the user adjusts the spaciousness. In some implementations, the system can interpolate between stored values to determine the parameters at some spaciousness settings. In some cases, different sets of available EQ parameter values can be used based on one more of the type of audio content, the type of pre-processing (or third party processing) performed on the audio signals, the audio mode of the speaker system, audio input type or source, bitstream type, and the user input.

By way of example, a speaker system can have various parameters that can be adjusted, such as based on the spaciousness input provided by the user, such as any combination of the L/R difference signal gain, the L/R difference delay, the L +R combination signal gain, the center channel gain, L signal gain, the R signal gain, The L/R mixer (210 and 214) settings, L and R filter or equalization parameters, L/R difference signal filter or equalization parameters, L +R combination signal filter or equalization parameters, the L-surround/R-surround difference signal gain, L-surround/R-surround difference delay, the L-surround +R-surround combination signal gain, the L-surround gain, the R-surround gain, the L-surround/R-surround mixer (312 and 314) settings, the L-surround and R-surround filter parameters, L-surround/R-surround difference signal filter or equalization parameters, L-surround +R-surround combination signal filter or equalization parameters, the L-elevation/R-elevation difference signal gain, the L-elevation/R-elevation difference delay, the L-elevation +R-elevation combination signal gain, the L-elevation gain, the R-elevation gain, the L-elevation/R-elevation mixer (similar to 312 and 314) settings, the L-elevation and R-elevation filter parameters, L-elevation/R-elevation difference signal filter or equalization parameters, L-elevation +R-elevation combination signal filter or equalization parameters, etc. The speaker system 100 can have several (e.g., 101) values for some or all of these parameters, which can be applied based on user input to adjust the spaciousness. Different sets of available values can be used based on one more of the type of audio content, the type of pre-processing (or third party processing) performed on the audio signals, the audio mode of the speaker system, audio input type or source, bitstream type, and the user input. The system can store parameter values for each incremental spaciousness setting, or the system can store a smaller number of parameter values and can interpolate between stored values based on the incremental spaciousness setting.

The user interface 116 can be configured to receive user input to specify a type of audio content or an audio mode for the speaker system. For example, the user can select from various different audio modes such as music, movie, TV, dialog, party, sports, video game, etc. In some cases, the user can provide input to select the audio input, such as HDMI, RCA, USB, Optical, etc. The speaker system can determine the spaciousness parameters based at least in part on the type of audio content, the audio mode, and/or the input type that is specified by the user.

In some implementations, the speaker system can automatically determine the type of audio content or audio mode or input type. For example, the speaker system can determine which physical port or input connector received audio data, or whether the audio data was received wirelessly. The speaker system can determine how many channels the audio data includes. In some cases, the speaker system can receive audio data that includes metadata, and the speaker system can read the metadata to determine a type of audio. For example, in some cases, the metadata can directly indicate an audio type (e.g., music or movie or podcast, etc.). In some cases, the speaker system can determine the audio type from other metadata. For example, if the metadata includes an album, artist, and track name the speaker system can use that information to determine that the audio content is music. If the source of a received bitstream is a movie or TV provider service, the speaker system can determine that the audio content is for a movie or TV. If the bitstream source is from a music app, then the audio content can be determined to be music. The speaker system can determine the spaciousness parameters based at least in part on the type of audio content, the audio mode, and/or the input type. In some cases, the speaker system can determine a type of audio content and/or what spaciousness parameters to apply based at least in part on the physical input source of the audio signals (e.g., whether the audio signals were received by RCA ports, or and HDMI port, or using an eARC input, etc.).

By way of example, the speaker system can determine that the audio content contains two channels (e.g., L and R channels), and in response to that determination, the speaker system can apply the spaciousness settings of FIG. 9 (e.g., with a default spaciousness setting that includes a separation signal gain of −12 dB). In another example, the speaker system can determine that the audio content contains height channels, and in response to that determination, the speaker system can apply the spaciousness settings of FIG. 10 (e.g., with a default spaciousness setting that includes a separation signal gain of −6 dB). If two-channel audio content is received via an RCA input, the speaker system can determine that the audio content is music, and in response to that determination the speaker system can apply the adjustable spaciousness settings that include the gain profile of line 502 in FIG. 11. If two-channel audio content is received via an eARC input, the speaker system can determine that the audio content is from a movie or TV category, and in response to that determination the speaker system can apply the adjustable spaciousness settings that include the gain profile of line 504 in FIG. 11.

In some embodiments, the user interface 116 of the speaker system can be configured to receive user input to change or specify the audio type, and the user input can override an audio type determined by the speaker system. If the speaker system were to incorrectly determine an audio type, the user could provide input to change the audio type. In some situations, a user might prefer to use the spaciousness or other settings from a different type of audio. For example, a user might prefer to use the settings for music when watching a movie, or to use the movie settings when listening to music, and the user interface can enable the user to provide input to specify those settings. The user can further adjust the spaciousness (e.g., incrementally) from the default settings, as discussed herein.

In some embodiments, the speaker system can include multiple pairs or sets of drivers or speakers, which can be arranged in left and right pairs (e.g., front left and front right, rear left and rear right, side left and sight right, height left and height right). The speaker system can enable the user to adjust or otherwise control the spaciousness of the different pairs or sets of drivers or speakers independently. For example, the user can adjust the spaciousness for the front left/right drivers differently from the spaciousness for the rear left/right drivers. In some cases, when the user adjusts the spaciousness, that adjustment can be applied to multiple sets or pairs of drivers. For example, the user can provide a command to adjust the spaciousness, and the speaker system can change the spaciousness accordingly for the front left/right drivers and also for the rear left/right drivers, etc.

In some cases, the user interface can enable the user to specify one or more user presets for spaciousness parameters. For example, the user can operate the user interface to adjust the spaciousness to a desired set of parameters. The user can then hold a button, or engage any other suitable input element, to save those parameters as a preset. Later, the user can use the user interface to select that preset (e.g., by pressing a button or engaging any other suitable input element), and cause the speaker system to apply the previously set spaciousness parameters.

The speaker system can return to the default spaciousness settings for each audio type, such as when the speaker system is turned on or off, or when the speaker system changes the audio type or audio input. In some implementations, the speaker system can remember the adjusted spaciousness parameters, and can apply those adjusted spaciousness parameters (e.g., for the specific audio type or mode), until they are changed. In some cases, the user adjustment can change the default spaciousness parameters (e.g., for that types of audio or mode). The speaker system can store different presets or other use-specific spaciousness preferences for one or more users. For multiple users, the speaker system can determine which user is using the speaker system, such as using voice recognition.

In some embodiments, the speaker system can detect an environment or use of the speaker system and can determine the spaciousness setting based on that information. By way of example, the speaker system can include one or more microphones (e.g., as part of the user interface 116). The one or more microphones can identify the voices from multiple users in the vicinity. In some cases, the one or more microphones can determine which directions the voices are coming from. The speaker system can use this information to determine that the listening area includes several different people that are spread out around the room (e.g., indicating a possible party). The speaker system can select a relatively narrow spaciousness setting under those circumstances. For example, the speaker system can change the audio mode to a more narrow audio mode. Alternatively, the speaker system can adjust the spaciousness within the audio mode that it was using.

In some cases, the speaker system can be configured to produce phantom speakers at locations outside of the speaker system (e.g., outside of a single-enclosure speaker system). The speaker system can adjust the spaciousness or width of the soundstage using those phantom speakers. The speaker system can be headphones, ear buds, an automobile sound system, a soundbar, or any other suitable speaker system or device.

In some implementations, mixing opposing channels with polarity-inverted elements (e.g., an inverted L signal mixed with an R signal reproduced by the R channel loudspeaker or driver) can effectively yield interaural crosstalk cancellation (IACC). The inverted signal elements can be delayed, for example such that their arrival at the listener's ears is substantially synchronous with contralateral audio signals (e.g., sound from the inverted-L signal from R channel loudspeaker reaches the listener's right ear simultaneously with sound from the L signal from the L speaker). In some implementations, the speaker systems disclosed herein can be configured or operable to provide interaural crosstalk cancellation. For example, as shown in FIG. 2, the Rᵢₙ signal can be inverted (at 202) and delayed (at 205) and the resulting signal can be provided to the left driver 104. Additional features and details relating to interaural crosstalk cancellation that can be applied to the speaker systems disclosed herein are disclosed in U.S. Patent Application Publication No. 2023/0319478, published on Oct. 5, 2023, and titled LOUDSPEAKER SYSTEMS, which is incorporated by reference and made a part of this application for all that it discloses.

In some embodiments, the speaker system can provide for height or elevation audio channels. The spaciousness control can adjust the presentation of sound in the vertical dimension as well as, or instead of, horizontal. In some embodiments, the speaker system can include one or more speakers configured to output sounds to create an impression of height, or sound coming from above the listening space. One or more height or elevation speakers can be mounted in or on the ceiling, in some cases, or one or more speakers can direct sound upward so that the sound reflects off of the ceiling. By way of example, the speaker system 350 of FIG. 7 can be modified to include a left elevation (LE) speaker and a right elevation (RE) speaker, which can each include one or more drivers. In some embodiments, the soundstage can be made taller or shorter, by adjusting the gain applied to the elevation audio signals (e.g., LE and RE signals). Increasing the gain applied to the elevation signals can increase the spaciousness or widen the soundstage (e.g., in the vertical direction), and/or decreasing the gain applied to the elevation signals can decrease the spaciousness or narrow the sound stage (e.g., in the vertical direction). In some cases, the vertical spaciousness and horizontal spaciousness can be controlled independently, or they can be controlled together using overall spaciousness settings. Delay can be applied to the elevation signals to adjust the spaciousness, similar to other embodiments discussed herein. Increased delay to the elevation signals can increase spaciousness or widen the soundstage (e.g., vertically). Decreased delay to the elevations signals can decrease spaciousness or narrow the soundstage (e.g., vertically). The system can use different default spaciousness settings for different types of audio, and user adjustments to the spaciousness can produce different changes depending on the type of audio, similar to other embodiments discussed herein.

In some embodiments, the soundstage can be made taller or shorter, by adjusting parameters similar to the other embodiments disclosed herein. For example, the example of FIG. 2 can be modified so that left driver is replaced with a right elevation (RE) driver. The Lᵢₙ signal would be changed to a REᵢₙ signal and the Lₒᵤₜ signal would be changed to an REₒᵤₜ signal. The signal processing elements can determine a difference signal between the Rᵢₙ and the REᵢₙ signals, and that difference signal can be used to increase or decrease the height of the soundstage, similar to the horizontal widening disclosure herein. A combination signal can be produced (e.g., representing similarity between the Rᵢₙ and the REᵢₙ signals), which can be used to increase or decrease the height of the soundstage. A similar approach can be applied to the left driver and a left elevation (LE) driver, e.g., in coordination with the right side, to increase or decrease the height of the soundstage. For that feature, FIG. 2 can be modified to replace the right driver with a left elevation (LE) driver, and to replace the Rᵢₙ signal with a Leᵢₙ signal, and to replace the Rₒᵤₜ signal with an LEₒᵤₜ signal. The example embodiments of FIGS. 3 to 6, or any of the other examples, could be modified similarly to provide adjustable elevation spaciousness. The speaker system can have adjustable horizontal spaciousness and/or vertical spaciousness, which can be adjusted independently or together.

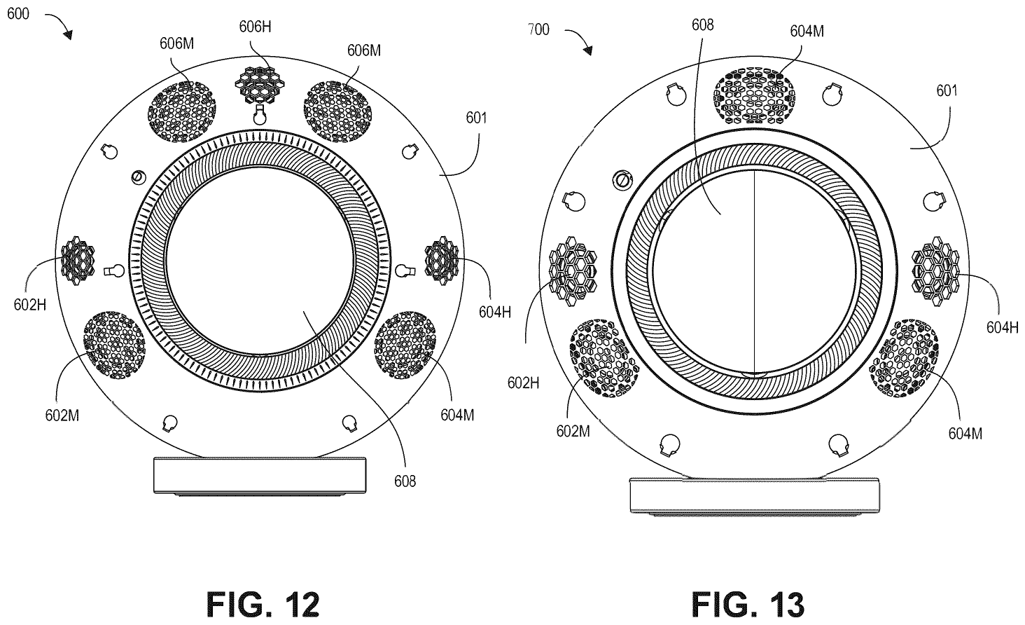

FIG. 12 shows an example embodiments of a speaker system 600 that can be similar to the speaker systems disclosed in U.S. Patent Application Publication No. 2024/0080594, which is incorporated herein by reference. The speaker system 600 can include a housing 601, which can support multiple drivers. The speaker system 600 can include a multiple left drivers, such as a left high-range driver 602H (e.g., a tweeter) and a left driver 602M that has a lower frequency range than the driver 602H. Driver 602M can be a mid-range driver or a full-range driver, for example. The speaker system 600 can include a multiple right drivers, such as a right high-range driver 604H (e.g., a tweeter) and a right driver 604M that has a lower frequency range than the driver 604H. Driver 604M can be a mid-range driver or a full-range driver, for example. The speaker system 600 can include a multiple center/height drivers, such as a center/height high-range driver 606H (e.g., a tweeter) and two center/height drivers 606M that have a lower frequency range than the driver 606H. Drivers 606M can be mid-range drivers or full-range drivers, for example. The speaker system can include a low-range driver of subwoofer 608, which can have a lower frequency range than the high-range or mid-range drivers.

FIG. 13 shows another example embodiment of the speaker system 700, which can be similar to the speaker system 600 of FIG. 12, except as shown and described. The speaker system 700 can include one center/height driver 604M. The example speaker 700 does not include a center/height high-frequency driver 604H. Many variations are possible, and the speaker systems can include one or more of each of the drivers 602H, 602M, 604H, 604M, 606H, 606M, and 608. The speaker systems 600 and 700 can implement the adjustable spaciousness features disclosed herein.

In some embodiments, the speaker system can use a shared center and height driver. Additional features and details are disclosed in U.S. Provisional Ser. No. 63/695,151 , filed Sep. 16, 2024, and titled SYSTEM AND METHOD FOR USE OF CENTER CHANNEL TO CREATE HEIGHT VIA NULL FORMING, and in U.S. patent application Ser. No. 19/329,444, filed Sep. 15, 2025, and titled SYSTEM AND METHOD FOR USE OF CENTER CHANNEL TO CREATE HEIGHT VIA NULL FORMING, which are incorporated by reference and made a part of this application for all that they disclose. The center/height driver can be aimed generally upward and forward. The center/height driver can play audio based on a center channel audio signal and also based on one or more elevation channel signals (e.g., LE and RE channel signals). Some of the sound from the center channel signals can travel directly to the user, and some of the sound from the center channel signals can bounce off of a ceiling and approach the user from above. The precedence effect can result in the user perceiving the center channel sounds as originating from the center speaker rather than from the ceiling above. Some of the sound from the sound from the elevation signals can bounce off of the ceiling and approach the user from above, which can provide an impression of height or elevation. However, some of the sound from the elevation signals can travel directly from the center/height driver to the user, which could impair the height effects. One or more other drivers (e.g., the L and R speakers) can play elevation cancelation signals to at least partially cancel the direct sounds from the elevation signals, which can create a null at the listening location. For example, the L and R speakers can play sounds based on an inverted version of the elevation signals used to drive the center/height speaker. For example, the elevation signals can be inverted and those inverted elevation signals can be used to drive the L and R speakers. In some cases, the inverted elevation signals can interfere with the sound from the L and R channel signals produced by the L and R speakers, which can be undesired. Accordingly, in some embodiments the elevation signals are inverted and sent to the center/height speaker, and the elevation signals that are not inverted are used to drive the L and R speakers, which can provide the described cancelation of direct height sounds, while reducing interference with the L and R channel sounds. A relative delay between the elevation signals provided to the center/height speaker and the elevation cancellation signals provided to the L and R speakers can be adjusted to move the location of the null, such as to steer or aim the direction of the null upward or downward.

Accordingly, the LE (left elevation) and RE (right elevation) signals can be used (sometimes with a phase inversion) to produce the L, R and/or C/H output signals. As the spaciousness control is turned up, the gain applied to LE and/or RE can be increased. Also, a delay that is used to aim the null can be adjusted (e.g., for a smaller room) as the spaciousness is adjusted. At the minimum end of the spaciousness control (e.g., at the mono end) the phase inversion can be taken out, LE and RE levels can be decreased, and there can be no delay. Filtering of LE, RE signals and their inversions can be varied across the range of the spaciousness control. The signals going to the Center and/or L/R channels can be filtered independently across the range of the control. The height of the soundstage can be adjusted as part of the spaciousness adjustment.

The amount of gain applied the LE and RE signals (LE/RE gain) parameter can affect the spaciousness. Generally, increasing the LE/RE gain can produce more spaciousness, and decreasing the LE/RE gain can produce less spaciousness. For example, the amount of gain applied to the LE and RE signals that are sent to the left elevation and right elevation drivers (LE/RE to LE/RE gain) can affect the spaciousness. Generally, increasing the LE/RE to LE/RE gain can produce more spaciousness, and decreasing the LE/RE to LE/RE gain can produce less spaciousness. In some cases, the LE and RE signals can be sent to other drivers as well. In some cases, the amount of gain applied to the LE and RE signals that are sent to the left and right drivers (LE/RE to L/R gain) can affect the spaciousness. Generally, increasing the LE/RE to L/R gain can produce more spaciousness, and decreasing the LE/RE to L/R gain can produce less spaciousness. The amount of gain applied to the LE and RE signals that are sent to the center driver (LE/RE to C gain) can affect the spaciousness. Generally, increasing the LE/RE to C gain can produce less spaciousness (more mono sound), and/or decreasing the LE/RE to C gain can produce more spaciousness.

In some implementations, the LE and RE signals (e.g., sent to the center/height driver) can be inverted for a first group of spaciousness settings and not inverted for a second group of speciousness settings that are lower (e.g., narrower) than the first group of spaciousness settings. For example, when trying to make mono sound or a narrow soundstage, it can be beneficial to use the un-inverted LE and RE signals for the center/height driver and/or for the left and right drivers. When trying to create height audio effects or a wide soundstage, it can be beneficial to use inverted LE and RE signals for the center/height driver or for the left and right drivers (e.g., to cancel the direct elevation sounds). However, when creating a narrow soundstage or low spaciousness or mono sound, the inverted LE and RE signals can created undesired cancelations. Accordingly, the inverted LE and RE signals can be attenuated or omitted for a narrow soundstage, low spaciousness, or mono sound.

The amount of delay applied to the LE and RE signals can affect the spaciousness. The delay for the LE and RE signals provided to the left elevation and right elevation drivers (LE/RE to LE/RE delay) can affect the spaciousness. Generally, increasing the LE/RE to LE/RE delay can produce more spaciousness, and decreasing the LE/RE to LE/RE delay can produce less spaciousness. In some implementations, the LE and RE signals can be used with other speakers as well. Generally, increasing the delay for the LE and RE signals driving the L and R speakers (e.g., LE/RE to L/R delay) can produce more spaciousness, and decreasing the LE/RE to LE/RE delay can produce less spaciousness.

In the combined center/height speaker embodiments, the amount of delay applied to the LE and RE signals provided to the center/height driver (LE/RE to C delay) can affect the spaciousness. Generally, increasing the LE/RE to C/H delay can produce more spaciousness, and decreasing the LE/RE to C/H delay can produce less spaciousness. In some implementations, as the spaciousness increases, more delay can be applied to the LE/RE to C delay than to the LE/RE cancelation signal delay for the L/R speakers, which can change the position of the Null.

The speaker system 100 can have several (e.g., 101) values for some or all of these height or elevation parameters, which can be applied based on user input to adjust the spaciousness. In some implementations, the system can interpolate between stored values to determine the parameters. In some cases, different sets of available values can be used based on one more of the type of audio content, the type of pre-processing (or third party processing) performed on the audio signals, the audio mode of the speaker system, audio input type or source, bitstream type, and the user input.

### Additional Information

In some embodiments, the methods, techniques, microprocessors, and/or controllers described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are programmed to perform the techniques, or may include one or more general purpose hardware processors programmed to perform the techniques pursuant to program instructions in firmware, memory, other storage, or a combination thereof. The instructions can reside in RAM memory, flash memory, ROM memory, EPROM memory, EEPROM memory, registers, hard disk, a removable disk, a CD-ROM, or any other form of a non-transitory computer-readable storage medium. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

The microprocessors or controllers described herein can be coordinated by operating system software, such as iOS, Android, Chrome OS, Windows XP, Windows Vista, Windows 7, Windows 8, Windows 10, Windows Server, Windows CE, Unix, Linux, SunOS, Solaris, iOS, Blackberry OS, VxWorks, or other compatible operating systems. In other embodiments, the computing device may be controlled by a proprietary operating system. Conventional operating systems control and schedule computer processes for execution, perform memory management, provide file system, networking, I/O services, and provide a user interface functionality, such as a graphical user interface (“GUI”), among other things.

The microprocessors and/or controllers described herein may implement the techniques described herein using customized hard-wired logic, one or more ASICs or FPGAs, firmware and/or program logic which causes microprocessors and/or controllers to be a special-purpose machine. According to one embodiment, parts of the techniques disclosed herein are performed a controller in response to executing one or more sequences instructions contained in a memory. Such instructions may be read into the memory from another storage medium, such as storage device. Execution of the sequences of instructions contained in the memory causes the processor or controller to perform the process steps described herein. In alternative embodiments, hard-wired circuitry may be used in place of or in combination with software instructions.

Moreover, the various illustrative logical blocks and modules described in connection with the embodiments disclosed herein can be implemented or performed by a machine, such as a processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. For example, some or all of the techniques described herein may be implemented in analog circuitry or mixed analog and digital circuitry.

Unless the context clearly requires otherwise, throughout the description and the claims, the words “comprise,” “comprising,” “include,” “including,” and the like are to be construed in an inclusive sense, as opposed to an exclusive or exhaustive sense; that is to say, in the sense of “including, but not limited to. ” The words “coupled” or connected,” as generally used herein, refer to two or more elements that can be either directly connected, or connected by way of one or more intermediate elements. Additionally, the words “herein,” “above,” “below,” and words of similar import, when used in this application, shall refer to this application as a whole and not to any particular portions of this application. Where the context permits, words in the Detailed Description using the singular or plural number can also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a range of measurement error.

Although this disclosure contains certain embodiments and examples, it will be understood by those skilled in the art that the scope extends beyond the specifically disclosed embodiments to other alternative embodiments and/or uses and obvious modifications and equivalents thereof. In addition, while several variations of the embodiments have been shown and described in detail, other modifications will be readily apparent to those of skill in the art based upon this disclosure. It is also contemplated that various combinations or sub-combinations of the specific features and aspects of the embodiments may be made and still fall within the scope of this disclosure. It should be understood that various features and aspects of the disclosed embodiments can be combined with, or substituted for, one another in order to form varying modes of the embodiments. Any methods disclosed herein need not be performed in the order recited. Thus, it is intended that the scope should not be limited by the particular embodiments described above.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. Any headings used herein are for the convenience of the reader only and are not meant to limit the scope.

Further, while the devices, systems, and methods described herein may be susceptible to various modifications and alternative forms, specific examples thereof have been shown in the drawings and are herein described in detail. It should be understood, however, that the disclosure is not to be limited to the particular forms or methods disclosed, but, to the contrary, this disclosure covers all modifications, equivalents, and alternatives falling within the spirit and scope of the various implementations described. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication.

The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm. ” Phrases preceded by a term such as “substantially” include the recited phrase and should be interpreted based on the circumstances (e.g., as much as reasonably possible under the circumstances). For example, “substantially constant” includes “constant. ” Unless stated otherwise, all measurements are at standard conditions including ambient temperature and pressure.

The following is claimed:

1. A speaker system comprising:
a left driver;
a right driver;
an interface configured to receive spaciousness adjustment user input information;
at least one processor; and
computer-readable memory that contains first spaciousness settings for a first type of audio that includes a first default gain value, second spaciousness settings for a second type of audio that includes a second default gain value different from the first default gain value, and instructions configured to be executed by the processor to cause the processor to:
receive audio data that includes a left audio signal and a right audio signal;
determine that the received audio data is the first type of audio;
determine a difference signal based at least in part on a difference between the left audio signal and the right audio signal;
apply the first default gain value from the first spaciousness settings for the first type of audio to the difference signal to produce a processed difference signal;
produce a left audio output signal and a right audio output signal based at least in part on the processed difference signal;
provide the left audio output signal to the left driver and provide the right audio output signal to the right driver to output sound having a default spaciousness for the first type of audio;
receive user input information indicating a spaciousness adjustment;
determine an adjustment gain value based at least in part on the received user input information;
apply the adjustment gain value to produce an adjusted difference signal;
produce an adjusted left audio output signal and a right adjusted audio output signal based at least in part on the adjusted difference signal; and
provide the adjusted left audio output signal to the left driver and provide the adjusted right audio output signal to the right driver to output sound having an adjusted spaciousness.

2. The speaker system of claim 1, wherein the spaciousness adjustment user input information is a command to incrementally widen or incrementally narrow the spaciousness of the output sound.

3. The speaker system of claim 1, wherein the instructions are configured to cause the processor to determine that the received audio data is a first type of audio based at least in part on user input information.

4. The speaker system of claim 1, wherein the instructions are configured to cause the processor to determine that the received audio data is a first type of audio based at least in part on a physical input source of the audio data.

5. The speaker system of claim 1, wherein the instructions are configured to cause the processor to determine that the received audio data is a first type of audio based at least in part on metadata of the audio data.

6. The speaker system of claim 1, wherein the instructions are configured to cause the processor to change from the first spaciousness settings for the first type of audio to the second spaciousness settings for the second type of audio based at least in part on user input information.

7. The speaker system of claim 1, wherein the instructions are configured to cause the processor to apply the first default gain value using a first signal processing element, and to apply the adjustment gain value by changing the first default gain value to an adjusted gain value applied by the same first signal processing element.

8. The speaker system of claim 1, wherein the instructions are configured to cause the processor to apply the first default gain value using a first signal processing element, and to apply the adjustment gain value using a second signal processing feature different from the first signal processing feature.

9. The speaker system of claim 1, wherein the instructions are configured to cause the processor to:
determine a combination signal based at least in part on the left audio signal and the right audio signal, wherein the combination signal is indicative of similarity between the left audio signal and the right audio signal, apply a default combination
signal gain value from the first spaciousness settings to the combination signal to produce a processed combination signal;
produce the left audio output signal and the right audio output signal based at least in part on the processed combination signal;
determine an adjustment combination gain value based at least in part on the received user input information;
apply the adjustment combination gain value to produce an adjusted combination signal; and
produce the adjusted left audio output signal and the right adjusted audio output signal based at least in part on the adjusted combination signal.

10. The speaker system of claim 1, wherein the instructions are configured to cause the processor to implement:
a first mixer configured to receive:
a left audio signal;
a left difference signal; and
a combination signal;
wherein the first mixer is configured to adjust gain to one or more of the received signals in response to the user input information indicating the spaciousness adjustment; and
a second mixer configured to receive:
a right audio signal;
a right difference signal; and
the combination signal;
wherein the second mixer is configured to adjust gain to one or more of the received signals in response to the user input information indicating the spaciousness adjustment.

11. The speaker system of claim 1, comprising an additional left driver and an additional right driver, wherein the speaker system is configured to enable user adjustment of the additional left driver and the additional right driver independent of the left driver and the right driver.

12. The speaker system of claim 1, wherein the first spaciousness settings for the first type of audio includes a first default delay value, wherein the second spaciousness settings for the second type of audio includes a second default delay value, and wherein the instructions are configured to cause the processor to:
apply the first default delay value from the first spaciousness settings for the first type of audio to the difference signal to produce the processed difference signal;
determine an adjustment delay value based at least in part on the received user input information; and
apply the adjustment delay value to produce the adjusted difference signal.

13. A speaker system comprising:
multiple acoustic transducers;
an interface configured to receive user input information; and
one or more signal processing elements configured to:
receive audio input signals;
process the audio input signals according to spaciousness parameters; and
provide audio output signals to the multiple acoustic transducers to produce sound that has spaciousness according to the spaciousness parameters;
wherein the speaker system is configured to determine a range of spaciousness parameters based at least in part on the received audio input signals or a selected audio mode, and wherein the speaker system is configured to determine the spaciousness parameters based at least in part on user input and the determined range of spaciousness parameters.

14. The speaker system of claim 13, wherein the speaker system is configured to determine a type of audio based at least in part on the received audio input signals, and wherein the speaker system is configured to determine the range of spaciousness parameters based at least in part on the type of audio.

15. The speaker system of claim 13, wherein the speaker system is configured to determine default spaciousness parameters based at least in part on the received audio input signals or a selected audio mode, and wherein the range of spaciousness parameters is between the default spaciousness parameters and maximum spaciousness parameters.

16. The speaker system of claim 15, wherein the interface is configured to receive a command to incrementally increase the spaciousness, and wherein the speaker system is configured to incrementally increase the spaciousness from the default spaciousness parameters toward the maximum spaciousness parameters in response to the command.

17. The speaker system of claim 13, wherein the speaker system is configured to determine a type of audio from the received audio input signals and to determine the range of spaciousness parameters based at least in part on determined type of audio.

18. The speaker system of claim 13, wherein the speaker system is configured to determine the range of spaciousness parameters based at least in part on metadata of the received audio signals.

19. The speaker system of claim 13, wherein the one or more signal processing elements are implemented using a digital signal processor.

20. The speaker system of claim 13, wherein the one or more signal processing elements include analog signal processing elements.

21. The speaker system of claim 13, wherein the speaker system is configured to adjust gain applied to a difference signal based on a difference between a first audio signal and a second audio signal to adjust the spaciousness of sound output by the speaker system.

22. The speaker system of claim 21, wherein the speaker system is configured to adjust delay applied to the difference signal to adjust the spaciousness of sound output by the speaker system.

23. The speaker system of claim 13, wherein the speaker system is configured to adjust a height of a soundstage produced by the speaker system.

24. A speaker system comprising:
multiple acoustic transducers;
an interface configured to receive user input information including a command to incrementally widen or narrow audio output by the multiple acoustic transducers;
one or more signal processing elements configured to:
receive audio input signals; and
process the audio input signals and provide processed audio output signals to the multiple acoustic transducers;
wherein the speaker system uses the one or more signal processing elements to modify the processed audio output signals to incrementally widen or narrow the audio output by the multiple acoustic transducers.

25. The speaker system of claim 24, wherein the speaker system is configured to determine a default width for the audio output by the multiple transducers.

26. The speaker system of claim 25, wherein the speaker system is configured to determine a type of audio for the audio input signal, and wherein the speaker system is configured to determine the default width based at least in part on the type of audio.

27. The speaker system of claim 25, wherein the default width for the audio is determined from an audio mode that is set using a user interface.

28. The speaker system of claim 25, wherein the interface is configured to receive user command information to incrementally narrow the audio, and wherein the speaker system is configured to incrementally narrow the audio from the default width towards a minimum width in response to the user command information.

29. The speaker system of claim 24, wherein the speaker system is configured to adjust gain applied to a difference signal based on a difference between a first audio signal and a second audio signal to adjust the spaciousness of audio output by the multiple acoustic transducers.

30. The speaker system of claim 24, wherein the speaker system is configured to adjust delay applied to a difference signal based on a difference between a first audio signal and a second audio signal to adjust the spaciousness of audio output by the multiple acoustic transducers.

31. The speaker system of claim 24, wherein the speaker system is configured to adjust a height of the audio output by the multiple acoustic transducers.

32. A non-transitory computer-readable memory that includes instructions that are executable by a processor to cause a speaker system to:
receive audio data;
determine an audio type for the audio data;
determine a default spaciousness setting, a minimum spaciousness setting, and a maximum spaciousness setting based at least in part on the audio type; and
provide a user interface configured to receive user input to enable user adjustment of the spaciousness between the minimum spaciousness setting and the maximum spaciousness setting.

33. The non-transitory computer-readable memory of claim 32, wherein the instructions are configured to cause the speaker to determine the audio type for the audio data based one or more of:
a physical input source for the audio data;
a bitstream source for the audio data;
a user input received by the user interface; and
meta data for the audio data.

34. The non-transitory computer-readable memory of claim 32, wherein the instructions are configured to incrementally widen or incrementally narrow the spaciousness.

35. The non-transitory computer-readable memory of claim 32, wherein the instructions are configured to adjust gain applied to a difference signal that is based on a difference between a first audio signal and a second audio signal to adjust the spaciousness of audio output.
